(19) United States
(12) Patent Application Publication
(10) Pub. No.: US 2006/0063820 A1
(43) Pub. Date: Mar. 23, 2006

(54) 2,6-dihalo-4-(3,3-dichloro-allyloxy)-benzylalcohole derivatives having insecticidal and acaricidal properties

(76) Inventors: Peter Renold, Basel (CH); Werner Zambach, Basel (CH); Arthur Steiger, Basel (CH); Roger Graham Hall, Basel (CH); Olivier Loiseleur, Basel (CH); Stephan Trah, Basel (CH)

Correspondence Address: SYNGENTA CROP PROTECTION , INC.;PATENT AND TRADEMARK DEPARTMENT, 410 SWING ROAD, GREENSBORO, NC, 27409, US

(21) Appl. No.: 10/540,038

(22) PCT Filed: Dec. 22, 2003
(86) PCT No.: PCT/EP03/14757

§ 371 Date: Jun. 22, 2005

(30) Foreign Application Priority Data
Dec. 23, 2002 (CH) 2193/02

(51) Int. Cl. A01N 37/12; A01N 43/36; A01N 37/44

(52) U.S. Cl. 514/408; 514/563; 548/561; 562/450; 514/534; 514/595; 514/616; 514/562

(57) ABSTRACT

Compounds of formula (I), wherein A₁ is, for example, a bond or a C₁-C₆alkylene bridge; A₂ is, for example, a bond or C₁-C₆alkylene; A₃ is, for example, C₁-C₆alkylene; W is, for example, O or S; T is, for example, a bond, O, NH, NR₇, S, SO, SO₂, —C(═O)—O— or —O—C(═O)—; Q is a bond, O, NR₇, S, SO or SO₂; Y is O, NR₇, S, SO or SO₂; X₁ and X₂ are, each independently of the other, fluorine, chlorine, bromine or iodine; R₁ is, for example, halogen, CN, nitro, C₁-C₆alkyl or C₁-C₆haloalkyl; R₂ and R₃ are, for example, H, halogen, CN, nitro or C₁-C₆alkyl; R₇ is, for example, H, C₁-C₆alkyl or C₁-C₃haloalkyl; m is 1 or 2; and E is C₁-C₆alkyl, C₁-C₆haloalkyl, aryl or heterocyclyl; and, where applicable, possible E/Z isomers, mixtures of E/Z isomers and/or tautomers thereof, in each case in free form or in salt form; a process for the preparation of and the use of those compounds; pesticidal compositions in which the active ingredient has been selected from those compounds, or an agrochemically usable salt thereof; a process for the preparation of and the use of those compositions; plant propagation material treated with those compositions; and a method of controlling pests are described.

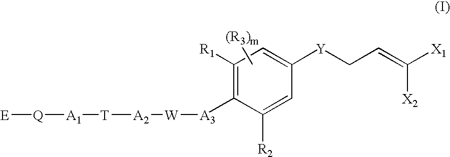

The present invention relates (1) to compounds of formula 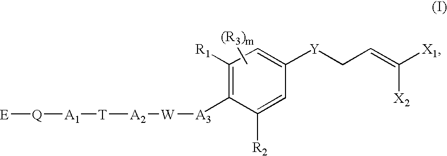
wherein
A₁ and A₂ independently of each other are a bond, C₁-C₆alkylene, C₂-C₆alkenylene or C₂-C₆alkynylene which are unsubstituted or substituted from one to six times by, each independently of the other(s), C₃-C₈cycloalkyl or C₁-C₃haloalkyl; or a ring of formula 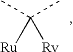
wherein the bonds indicated by --- denote the connections to the structural moieties W and T, or T and Q respectively, and Ru and Rv together are C₂-C₆alkylene;
A₃ is C₁-C₆alkylene, C₂-C₆alkenylene or C₂-C₆alkynylene which are unsubstituted or substituted from one to six times by, each independently of the other(s), C₃-C₈cycloalkyl or C₁-C₃haloalkyl;
W is O, NR₇, S, —C(═O)—O—, —O—C(═O)—, —O—C(═O)—NR₈—, —NR₈—C(═O)—O—, —NR₈C(═O)—NR₈—, —C(═O)—NH—NR₈— or —NR₈—NHC(═O)—;
T is a bond, O, NH, NR₇, S, SO, SO₂, —C(═O)—O—, —O—C(═O)—, —C(═O)—NR₈— or —NR₈—C(═O)—; or is a five- or six-membered, saturated or unsaturated ring, containing from one to three hetero atoms selected from O, S and N, which is unsubstituted or substituted by C₁-C₆alkyl and to which the adjacent groups A₁ and A₂ are bonded via carbon atoms of the ring;
Q is a bond, O, NR₇, S, SO or SO₂;
Y is O, NR₇, S, SO or SO₂;
X₁ and X₂ are each independently of the other fluorine, chlorine, bromine or iodine;
R₁ is halogen, CN, nitro, C₁-C₆alkyl, C₁-C₆haloalkyl, C₁-C₆alkylcarbonyl, C₂-C₆alkenyl, C₂-C₆haloalkenyl, C₂-C₆alkynyl, C₁-C₆alkoxy, C₁-C₆haloalkoxy, C₂-C₆alkenyloxy, C₂-C₆halo-alkenyloxy, C₂-C₆alkynyloxy, C₁-C₆alkoxycarbonyl or C₂-C₆haloalkenyloxy;
R₂ and R₃ are each independently of the other H, halogen, CN, nitro, C₁-C₆alkyl, C₁-C₆haloalkyl, C₁-C₆alkylcarbonyl, C₂-C₆alkenyl, C₂-C₆haloalkenyl, C₂-C₆alkynyl, C₁-C₆alkoxy, C₁-C₆haloalkoxy, C₂-C₆alkenyloxy, C₂-C₆haloalkenyloxy, C₂-C₆alkynyloxy, C₁-C₆alkoxycarbonyl or C₂-C₆haloalkenyloxy; the substituents R₃ being independent of one another when m is 2;
R₇ is H, —CHO, C₁-C₆alkyl, C₁-C₃haloalkyl, C₁-C₃haloalkylcarbonyl, C₁-C₆alkoxyalkyl, C₁-C₆alkylcarbonyl, C₁-C₆alkoxycarbonyl or C₃-C₈cycloalkyl;
R₈ is H, C₁-C₆alkyl, C₁-C₃haloalkyl, C₁-C₃haloalkylcarbonyl, C₁-C₆alkoxyalkyl, C₁-C₆alkylcarbonyl, C₃-C₈cycloalkyl or benzyl;
m is 1 or 2; and
E is C₁-C₆alkyl, C₃-C₈cycloalkyl, C₁-C₆haloalkyl, aryl or saturated or unsaturated heterocyclyl;
the aryl and heterocyclyl rings being unsubstituted or, depending on the substitution possibilities, substituted from one to five times by, each independently of the other(s), halogen, NH₂, OH, CN, nitro, C₁-C₆alkyl, C₁-C₆haloalkyl, C₁-C₆alkylcarbonyl, C₂-C₆alkenyl which is unsubstituted or substituted by halogen, CN or by benzoyl; C₂-C₆alkynyl, C₁-C₆alkoxy, C₁-C₆alkylthio, C₁-C₆haloalkoxy, C₁-C₆haloalkylthio, C₂-C₆alkenyloxy, C₂-C₆haloalkenyloxy, C₂-C₆alkynyloxy, C₁-C₆alkoxycarbonyl, C₂-C₆haloalkenyloxy, C₁-C₆haloalkyl, R₉, aryl, aryloxy, —O—CH₂-aryl, aminoaryl, heterocyclyl, heterocyclyloxy, —O—CH₂-heterocyclyl or aryl-C₁-C₆alkyl; or, substituting two adjacent ring atoms together, —O—CH₂—O— or —O—CF₂—O—;
it being possible for the last-mentioned aryl, aryloxy, —O—CH₂-aryl, aminoaryl, heterocyclyl, heterocyclyloxy, —O—CH₂-heterocyclyl and aryl-C₁-C₆alkyl groups to be unsubstituted or substituted by from one to three substituents selected each independently of the other(s) from halogen, CN, nitro, C₁-C₆alkyl, C₁-C₆haloalkyl, C₁-C₆alkoxy, C₁-C₆alkylthio and C₁-C₆haloalkoxy;
R₉ is —C(═NOR₁₀)—C₁-C₆alkyl; and
R₁₀ is H, C₁-C₆alkyl, C₃-C₆cycloalkyl-C₁-C₆alkyl, C₂-C₆alkenyl or C₂-C₆alkynyl;
and, where applicable, to possible E/Z isomers, mixtures of E/Z isomers and/or tautomers thereof, in each case in free form or in salt form,
with the proviso, that E is not pyrid-2-yl, which is substituted by CF₃ in the 5-position and unsubstituted or substituted by halogen in the 3-position, when A₃ is n-butylene or n-pentylene, W is oxygen, R₁ and R₂ are chlorine, m is 0, Y is oxygen, X₁ and X₂ are chlorine and A₁, A₂, T and Q are bonds;
to a process for the preparation of and to the use of those compounds and their E/Z isomers and tautomers, to pesticidal compositions in which the active ingredient has been selected from those compounds, their E/Z isomers and tautomers, and to a process for the preparation of and to the use of those compositions, to intermediates and, where applicable, to their possible E/Z isomers, mixtures of E/Z isomers and/or tautomers, in free form or in salt form, for the preparation of those compounds, where applicable to tautomers, in free form or in salt form, of those intermediates, and to a process for the preparation of and to the use of those intermediates and their tautomers.

Certain dihaloallyloxy derivatives are proposed in the literature as active ingredients in pesticidal compositions. The biological properties of those known compounds in the field of pest control are not, however, entirely satisfactory, for which reason there is a need to make available further compounds having pesticidal properties, especially for controlling insects and representatives of the order Acarina, that problem being solved in accordance with the invention by provision of the present compounds of formula (I).

The compounds of formula (I) and, where appropriate, tautomers thereof are capable of forming salts, for example acid addition salts. Those acid addition salts are formed, for example, with strong inorganic acids, such as mineral acids, e.g. sulfuric acid, a phosphoric acid or a hydrohalic acid, with strong organic carboxylic acids, such as unsubstituted or substituted, e.g. halo-substituted, C₁-C₄alkanecarboxylic acids, e.g. acetic acid, saturated or unsaturated dicarboxylic acids, e.g. oxalic, malonic, maleic, fumaric and phthalic acid, hydroxycarboxylic acids, e.g. ascorbic, lactic, malic, tartaric and citric acid, or benzoic acid, or with organic sulfonic acids, such as unsubstituted or substituted, e.g. halo-substituted, C₁-C₄alkane- or aryl-sulfonic acids, e.g. methane- or p-toluene-sulfonic acid. Furthermore, compounds of formula (I) having at least one acid group are capable of forming salts with bases. Suitable salts with bases are, for example, metal salts, such as alkali metal and alkaline earth metal salts, e.g. sodium, potassium and magnesium salts, and salts with ammonia or an organic amine, such as morpholine, piperidine, pyrrolidine, a mono-, di- or tri-lower alkylamine, e.g. ethyl-, diethyl-, triethyl- or dimethyl-propyl-amine, or a mono-, di- or tri-hydroxy-lower alkylamine, e.g. mono-, di- or tri-ethanolamine. In addition, corresponding internal salts may optionally also be formed. Preference is given, firstly, to the free form. Among the salts of compounds of formula (I) preference is given to agrochemically advantageous salts. The free compounds of formula (I) and salts thereof are to be understood hereinabove and hereinbelow as including, where appropriate, both the corresponding salts and the free compounds of formula (I), respectively. The same is correspondingly true for tautomers of compounds of formula (I) and salts thereof.

The general terms used hereinabove and hereinbelow have the following meanings, unless defined otherwise.

Halogen, both as a group per se and as a structural element of other groups and compounds, for example haloalkyl, halocycloalkyl, haloalkenyl, haloalkynyl and haloalkoxy, is fluorine, chlorine, bromine or iodine, especially fluorine, chlorine or bromine, more especially fluorine or chlorine, very especially chlorine Carbon-containing groups and compounds each contain, unless defined otherwise, from 1 up to and including 20, preferably from 1 up to and including 18, more preferably from 1 up to and including 10, especially from 1 up to and including 6, more preferably from 1 up to and including 4, even more especially from 1 up to and including 3, yet more especially 1 or 2, carbon atoms; very special preference is given to methyl.

Alkylene is a straight-chain or branched bridging member; it is, especially, —CH₂—, —CH₂CH₂—, —CH₂—CH₂—CH₂—, —CH₂—CH₂—CH₂—CH₂—, —CH₂—CH₂—CH₂—CH₂—CH₂—, —CH(CH₃)—, —CH₂(CH₃)CH₂—CH₂—, —CH(C₂H₅)—, —C(CH₃)₂—, —CH(CH₃)CH₂—, —CH(CH₃)CH(CH₃)— or —CH₂C(CH₃)₂—CH₂—.

Alkenylene is a straight-chain or branched bridging member having one or two, preferably one, double bond(s); it is, especially, —CH═C—, —CH═CH—CH₂—, —CH₂—CH═CH—CH₂—, —CH₂—CH₂═CH₂—CH₂—CH₂— or —CH(CH₃)CH═CH—.

Alkynylene is a straight-chain or branched bridging member having one or two, preferably one, triple bond(s); it is, especially, —C≡C—, —C≡C—CH₂—, —CH₂—C≡C—CH₂—, —CH₂—C≡C—CH₂—CH₂— or —CH(CH₃)C≡C—.

Alkyl, both as a group per se and as a structural element of other groups and compounds, for example of haloalkyl, alkoxy, alkoxyalkyl, haloalkoxy, alkoxycarbonyl, alkylthio, haloalkylthio, alkylsulfonyl and alkylsulfonyloxy, is, in each case taking due account of the particular number of carbon atoms contained in the group or compound in question, either straight-chained, e.g. methyl, ethyl, n-propyl, n-butyl, n-hexyl, n-octyl, n-decyl, n-dodecyl, n-hexadecyl or n-octadecyl, or branched, e.g. isopropyl, isobutyl, sec-butyl, tert-butyl, isopentyl, neopentyl or isohexyl.

Alkenyl and alkynyl, both as groups per se and as structural elements of other groups and compounds, for example of haloalkenyl, haloalkynyl, alkenyloxy, haloalkenyloxy, alkynyloxy or haloalkynyloxy, are straight-chained or branched and in each case contain two or, preferably, one unsaturated carbon-carbon bond(s). By way of example there may be mentioned vinyl, prop-2-en-1-yl, 2-methylprop-2-en-1-yl, but-2-en-1-yl, but-3-en-1-yl, prop-2-yn-1-yl, but-2-yn-1-yl and but-3-yn-1-yl.

Cycloalkyl, both as a group per se and as a structural element of other groups and compounds, for example of alkyl, is cyclopropyl, cyclobutyl, cyclopentyl, cyclohexyl, cycloheptyl or cyclooctyl. Preference is given to cyclopentyl and cyclohexyl and, especially, cyclopropyl.

Halo-substituted carbon-containing groups and compounds, for example haloalkyl and haloalkoxy, may be partially halogenated or perhalogenated, the halogen substituents in the case of multiple halogenation being identical or different. Examples of haloalkyl, both as a group per se and as a structural element of other groups and compounds, for example of haloalkoxy, are methyl mono- to tri-substituted by fluorine, chlorine and/or bromine, for example CHF₂, CF₃ or CH₂Cl; ethyl mono- to penta-substituted by fluorine, chlorine and/or bromine, for example CH₂CF₃, CF₂CF₃, CF₂CCl₃, CF₂CHCl₂, CF₂CHF₂, CF₂CFCl₂, CH₂CH₂C₁, CF₂CHBr₂, CF₂CHClF, CF₂CHBrF or CClFCHClF; propyl or isopropyl mono- to hepta-substituted by fluorine, chlorine and/or bromine, for example CH₂CHBrCH₂Br, CF₂CHFCF₃, CH₂CF₂CF₃, CF₂CF₂CF₃, CH(CF₃)₂ or CH₂CH₂CH₂Cl; and butyl, or one of the isomers thereof, mono- to nona-substituted by fluorine, chlorine and/or bromine, for example CF(CF₃)CHFCF₃, CF₂(CF₂)₂CF₃ or CH₂(CF₂)₂CF₃.

Aryl is, especially, phenyl or naphthyl; preference is given to phenyl.

Heterocyclyl, which comes into consideration as the substituent E, is understood to be a five- to seven-membered monocyclic ring containing from one to three hetero atoms selected from the group consisting of N, O and S, especially N and S, or a bicyclic ring system which may contain either in only one ring—for example in quinolyl, quinoxalinyl, indolinyl, benzothiophenyl or benzofuranyl—or in both rings—for example in pteridinyl or purinyl—, each independently of the other, one or more hetero atoms selected from N, O and S. The mentioned heterocycles may be saturated or unsaturated; in the case of the structural moieties designated E in formula (I), preference is given to aromatic heterocycles. Special preference is given to pyridyl, pyrimidyl, s-triazinyl, 1,2,4-triazinyl, tetrazolyl, thienyl, furyl, tetrahydrofuranyl, pyranyl, tetrahydropyranyl, pyrrolyl, pyrazolyl, imidazolyl, thiazolyl, triazolyl, oxazolyl, isoxazolyl, thiadiazolyl, oxadiazolyl, benzothienyl, quinolyl, quinoxalinyl, benzofuranyl, benzimidazolyl, benzopyrrolyl, benzothiazolyl, indolyl, coumarinyl or indazolyl, which are bonded preferably by way of a carbon atom; preference is given to thienyl, thiazolyl, benzofuranyl, benzothiazolyl, furyl, tetrahydropyranyl or indolyl; especially pyridyl or thiazolyl.

The heterocyclyl groups which come into consideration as bridging members T are understood to be, preferably, a five- or six-membered ring containing from one to three hetero atoms selected from the group consisting of N, O and S, especially N and O, and are, especially, saturated or partially saturated rings, for example dioxane, dioxolane, oxazoline, oxazolidine, oxadiazoline, oxadiazolidine, isoxazolidine, furan, dihydrofuran, tetrahydrofuran, imidazoline, imidazolidine, pyrroline, pyrazoline, pyrazolidine, thiazoline, thiazolidine, isothiazoline or isothiazolidine. Preference is given to each of the individual heterocycles mentioned.

Preferred embodiments in the context of the invention are
(2) compounds according to (1) of formula (I) wherein X₁ and X₂ are chlorine or bromine, especially chlorine;
(3) compounds according to (1) or (2) of formula (I) wherein A₁ is a bond;
(4) compounds according to (1) to (3) of formula (I) wherein the group A₂ is a bond;
(5) compounds according to (1) to (3) of formula (I) wherein the group A₂ is C₁-C₆alkylene-, especially —CH₂— or —CH₂—CH₂—;
(6) compounds according to (1) to (5) of formula (I) wherein W is oxygen;
(7) compounds according to (1) to (4) of formula (I) wherein W is NR₇, S, —O—C(═O)—NR₈—, —NR₈—C(═O)—O— or —NR₈C(═O)—NR₈—, and R₈ is hydrogen;
(8) compounds according to (1) to (7) of formula (I) wherein T is a bond;
(9) compounds according to (1) to (7) of formula (I) wherein T is O, —C(═O)—O—, —O—C(═O)—, —C(═O)—NH—, —NH—C(═O)—; or a five- or six-membered ring containing two oxygen atoms;
(10) compounds according to (1) to (9) of formula (I) wherein Q is a bond;
(11) compounds according to (1) to (10) of formula (I) wherein A₃ is a straight-chain C₁-C₆alkylene bridge, especially methylene, ethylene or propylene, more especially methylene;
(12) compounds according to (1) to (11) of formula (I) wherein Y is oxygen;
(13) compounds according to (1) to (12) of formula (I) wherein R₁ and R₂ are bromine or chlorine, especially chlorine;
(14) compounds according to (1) to (13) of formula (I) wherein R₃ is hydrogen;
(15) compounds according to (1) to (14) of formula (I) wherein E is phenyl;
(16) compounds according to (1) to (14) of formula (I) wherein E is heterocyclyl;
(17) compounds according to (1) to (14) and (16) of formula (I) wherein E is an unsubstituted or substituted heterocyclic 6-membered ring containing one or two nitrogen atoms;
(18) compounds according to (1) to (14) and (16) of formula (I) wherein E is an unsubstituted or substituted heterocyclic 5-membered ring containing one or two hetero atoms selected from O, N and S;
(19) compounds according to (17) or (18) of formula (I) wherein E is heteroaryl;
(20) compounds according to (1) to (10) and (12) to (19) of formula (I) wherein A₃ is C₃-C₆alkenylene or C₃-C₆alkynylene.

Special preference is given to the compounds indicated in the Tables.

The invention relates to a process for the preparation of compounds of formula (I), or salts thereof, which comprises converting
(a) a compound of formula 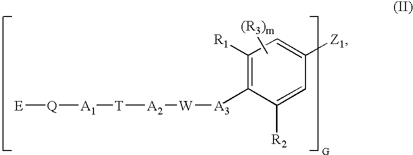
wherein A₁, A₂, A₃, Q, T, W, R₁, R₂, R₃, E and m are as defined for formula (I) under (1), Z₁ is —C(═O)R₁₁ and R₁₁ is H or C₁-C₆alkyl, in the presence of an oxidising agent, especially a peracid, into a compound of formula
   G-Z₂ₐ (IIIa),
wherein Z₂ₐ is O—C(═O)—R₁₂, R₁₂ is C₁-C₆alkyl and G is as defined for the bracketed moiety of formula (II) designated G; then either
(b₁) converting a compound of formula (IIIa) hereinabove or of formula
   G-Z_{2b} (IIIb),
wherein G is as defined for the bracketed moiety of formula (II) designated G, Z_{2b} is a radical of formula —Y—C(═O)R₁₃, Y is as defined for formula (I) under (1), and R₁₃ is C₁-C₁₂alkyl which is unsubstituted or substituted by from one to three halogen substituents, each independently of the other(s), or is phenyl which is unsubstituted or substituted by from one to three halogen, CN, nitro, C₁-C₆alkyl, C₁-C₆haloalkyl, C₁-C₆alkylcarbonyl, C₂-C₆alkenyl, C₂-C₆haloalkenyl, C₂-C₆alkynyl, C₁-C₆alkoxy, C₁-C₆haloalkoxy, C₁-C₆alkoxycarbonyl or C₂-C₆haloalkenyloxy substituents, each independently of the other(s), by hydrolytic cleavage, into a compound of formula
   G-Z₃ (IV),
wherein G is as defined for the bracketed moiety of formula (II) designated G, Z₃ is YH, and Y is as defined for formula (I) under (1); or
(c) converting a compound of formula
   G-Z₄ (V),
wherein Z is Y—CH₂-phenyl, wherein the phenyl radical is unsubstituted or substituted by from one to three halogen, CN, nitro, C₁-C₆alkyl, C₁-C₆haloalkyl, C₁-C₆alkylcarbonyl, C₂-C₆alkenyl, C₂-C₆haloalkenyl, C₂-C₆alkynyl, C₁-C₆alkoxy, C₁-C₆haloalkoxy, C₁-C₆alkoxycarbonyl or C₂-C₆haloalkenyloxy substituents, each independently of the other(s), G is as defined for the bracketed moiety of formula (II) designated G, and Y is as defined for formula (I), by cleavage of the benzyl group, into a compound of formula (IV), as defined hereinabove;
(d) reacting the resulting compound of formula (IV), in the presence of a base, with a compound of formula 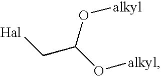
wherein Hal is a halogen, preferably bromine or chlorine, and alkyl is C₁-C₆alkyl, or the two alkyl radicals together form a C₃-C₈alkylene bridge, to form a compound of formula
   G-Z₅ (VI),
wherein G is as defined for the bracketed moiety of formula (II) designated G, and Z₅ is 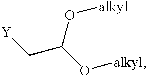
wherein alkyl and Y are as defined hereinabove;
(e) converting the resulting compound of formula (VI), by deprotection of the acetal function in the presence of an acid, into a compound of formula
   G-Z₆ (VII),
wherein Z₆ is a group —Y—CH₂—C(═O)H, G is as defined above for the compound of formula (II), and Y is as defined for formula (I) under (1); either
(f₁), for the purpose of preparing a compound of formula (I) wherein X₁ and X₂ are chlorine or bromine, reacting a compound of formula (VII), with a compound of formula C(X)₄ wherein X is chlorine or bromine, in the presence of a phosphine; or
(f₂), for the purpose of preparing a compound of formula (I) wherein X₁ and X₂ are chlorine, reacting a compound of formula (VII) first with CCl₃—COOH, or with chloroform in the presence of a strong base, then with acetic anhydride and then with zinc powder in acetic acid; or
(f₃), for the purpose of preparing a compound of formula (I) wherein X₁ is fluorine and X₂ is chlorine or bromine, reacting a compound of formula (VII) with a compound of formula CF₂X₂, of formula CFX₃, of formula CF₂XC(═O)ONa or of formula CFX₂C(═O)ONa in the presence of a phosphine; or
(g₁), for the purpose of preparing a compound of formula (I) wherein X₁ and X₂ are chlorine or bromine, reacting a compound of formula (IV) with a compound of formula 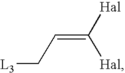
wherein L₃ is a leaving group, preferably chlorine or bromine, and Hal is chlorine or bromine, in the presence of a base; or
(g₂), for the purpose of preparing a compound of formula (I) wherein X, and X₂ are chlorine or bromine, reacting a compound of formula (IVa) or (IVb) with a compound of formula 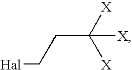
wherein Hal is a halogen, and X is chlorine or bromine, in the presence of a base.

The invention relates also to
(h) a process for the preparation of a compound of formula (I) as defined under (1), and wherein W is O, NR₇, S, SO, SO₂, —O—C(═O)—, —NR₈C(═O)—, —O—C(═O)—NR₈—, —NR₈—C(═O)—O—, —NR₈C(═O)—NR₈— or —NR₈—NHC(═O)— and R₇ and R₈ are as defined above under formula (I), which process comprises reacting a compound of formula
   E-Q-A₁-T-A₂-L₁ (VIII),
wherein E, A₁, A₂, Q and T are as defined for formula (I) under (1), and L₁ is a leaving group, in the presence of a base, with a compound of formula 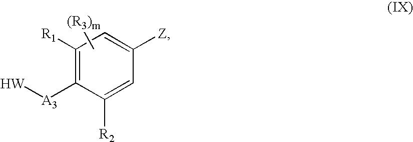
wherein R₁, R₂, R₃ and m are as defined for formula (I) under (1), W is O, NR₇ or S, R₇ is as defined for formula (I) under (1), and Z is one of the radicals Z₁ to 76 as defined in formulae (II) to (VII) hereinabove;
and further reacting the resulting compound of formula 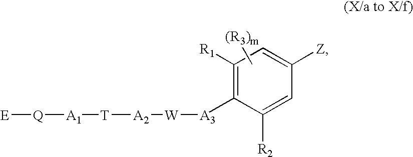
wherein A₁, A₂, A₃, E, Q, T, W, R₁, R₂, R₃ and m are as defined for formula (I) under (1), and Z is one of the radicals Z₁ to Z₆ as defined in formulae (II) to (VII) hereinabove, as required, that is to say in accordance with the particular meaning of the radical Z, in analogy to one or more of process steps (a) to (g).

In the compounds of formulae X/a to X/f, Z in compound X/a is as defined for Z₁ in the compound of formula (II), Z in compound X/b is as defined for Z₂ in formula (III), and so on.

The invention relates also to
(i₁) a process for the preparation of a compound of formula (I) as defined hereinabove, wherein T is O, NR₇, S, —O—C(═O)— or —NR₈—C(═O)—, and R₇ and R₈ are as defined for formula (I) under (1), which comprises reacting a compound of formula
   E-O-A₁-T₁-H (XI),
wherein A₁, E and Q are as defined for formula (I) under (1), and T₁ is O, NR₇, S or —NR₈—, with a compound of formula 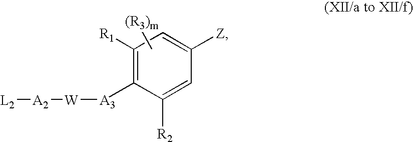
wherein A₂, A₃, R₁, R₂, R₃, W and m are as defined for formula (I) under (1), L₂ is a leaving group or a group Hal-C(═O)— wherein Hal is a halogen atom, preferably chlorine or bromine, and Z is one of the radicals Z₁ to Z₄ as defined in formulae (II) to (VII) hereinabove; or
(i₂), for the purpose of preparing a compound of formula (I) as defined hereinabove, wherein T is O, NR₇, S, —C(═O)—O— or —C(═O)—NR₈—, and R₇ and R₈ are as defined for formula (I) under (1), which comprises reacting a compound of formula
   E-Q-A₁-L₁ (XIII),
wherein A₁, Q and E are as defined for formula (I) under (1), and L₁ is a leaving group or a group —C(═O)-Hal wherein Hal is a halogen atom, preferably chlorine or bromine, with a compound of formula 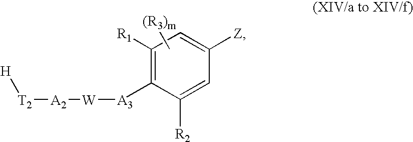
wherein T₂ is O, NR₇, S or NR₈, and R₇ and R₈ are as defined for formula (I) under (1),
and further reacting the resulting compound of formula (Xa) to (Xf), as defined hereinabove, as required, that is to say in accordance with the particular meaning of the radical Z, in analogy to one or more of process steps (a) to (g).

In the compounds of formulae XII/a to XII/f and XIV/a to XIV/f, the radicals Z are as defined hereinabove for the compounds X/a to X/f; accordingly, for example, Z in the compound of formula XII/a is as defined for Z₁ in the compound of formula (II), Z in the compound of formula XII/b is as defined for Z₂ in formula (III) and so on.

The invention relates also to
(k) a process for the preparation of compounds of formula (I) as defined hereinabove under (1), wherein W is O, NR₇, S, —O—C(═O)—NR₈—, —NR₈—C(═O)—O—, —NR₈C(═O)—NR₈— or —NR₈—NHC(═O)— and R₇ and R₈ are as defined hereinabove for formula (I), which comprises reacting a compound of formula (VIII) as defined hereinabove, in the presence of a base, with a compound of formula 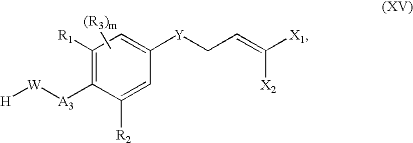
wherein A₃, R₁, R₂, R₃, W, X₁, X₂, Y and m are as defined for formula (I) under (1).

The invention relates also to
(I) a process for the preparation of a compound of formula (I) as defined hereinabove under (1), which comprises reacting a compound of formula (XI) as defined hereinabove, in analogous manner to process variant (i), with a compound of formula 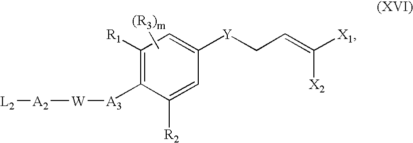
wherein A₂, A₃, R₁, R₂, R₃, Q, Y, X₁, X₂ and m are as defined for formula (I) under (1), and L₂ is as defined for formula (XII).

The invention relates also to
(m) a process for the preparation of a compound of formula (I) as defined hereinabove under (1), wherein W is —C(═O)—NR₈— or —C(═O)—NH—NR₈—, which comprises reacting a compound of formula (XI) wherein W₁ is O, NR₈ or NH₂—NR₈— and R₁, R₂, R₃, m and Z are as defined hereinabove, with a compound of formula 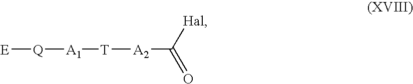
   wherein E, Q, A₁, T and A₂ are as defined hereinabove for formula (I) and Hal is a halogen atom; and, where appropriate, depending on the particular meaning of the radical Z, further reacting the resulting compound in analogy to one or more of process steps (a) to (g).

A further preparation process according to the invention comprises
(n), for the purpose of preparing a compound of formula (I) wherein W is —NR₈C(═O)—NH—, —NH—C(═O)—O— or —O—C(═O)—NH— and R₈ is as defined hereinabove, for example reacting a compound of formula 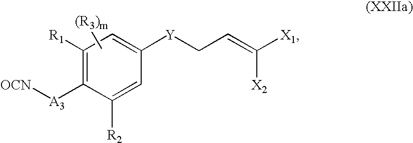
   wherein A₃, R₁, R₂, R₃, Y, X₁, X₂ and m are as defined for formula (I), with a compound of formula
   E-Q-A₁-T-A₂-N(R₈)H (XXIIIa),
   wherein E, Q, A₁, A₂, T and R₈ are as defined for formula (I), or of formula
   E-Q-A₁-T-A₂-OH (XXIIIb),
   wherein E, Q, A₁, A₂ and T are as defined for formula (I);
   or, for the purpose of preparing a compound of formula (I) wherein W is O, reacting a compound of formula (XXIIIb) hereinabove with a compound of formula 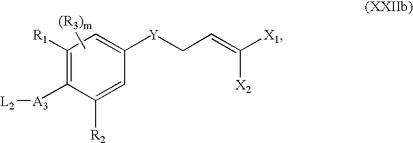
   wherein X₁, X₂, R₁, R₂, R₃, m and A₃ are as defined under formula (I); or
   (o) reacting a compound of formula 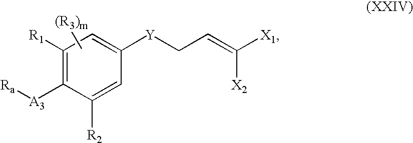
   wherein Rₐ is OH or —N(R₈)H and X₁, X₂, R₁, R₂, R₃, m and A₃ are as defined for formula (I), with a compound of formula
   E-O-A₁-T-A₂-NCO (XXV),
   wherein E, Q, A₁, A₂, T and A₂ are as defined hereinabove for formula (I).

The invention relates also to
(p) a process for the preparation of a compound of formula (I) wherein T is a five- or six-membered ring containing two oxygen atoms, which comprises reacting a compound of formula 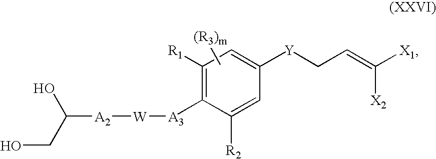
wherein A₂, A₃, R₁, R₂, R₃, W, Y, X₁, X₂ and m are as defined for formula (I), with a compound of formula 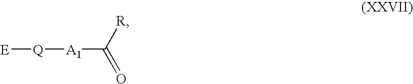
   wherein E, Q and A₁ are as defined for formula (I) and R is H or C₁-C₆alkyl; or
(q) reacting a compound of formula 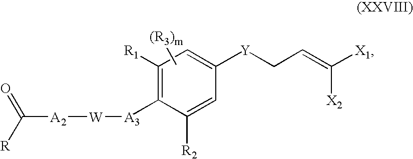
wherein A₂, A₃, R₁, R₂, R₃, W, Y, X₁, X₂ and m are as defined for formula (I) and R is H or C₁-C₆alkyl, with a compound of formula 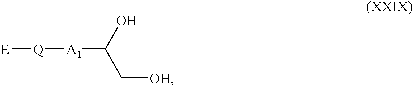
wherein E, Q and A₁ are as defined for formula (I).

The invention relates also to
(r) a process for the preparation of the compound of formula 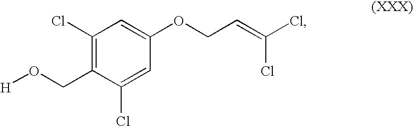
which comprises reacting 3,5-dichlorophenol first with formaldehyde and then, in the presence of a base, with 1,1,1,3-tetrachloropropane.

The invention relates also to the compounds of formulae (II) to (XXX), insofar as they are novel. The same preferences apply to those compounds of formulae (II) to (XXX) as to the compounds of formula (I).

The reactions described hereinabove and hereinbelow are carried out in a manner known per se, for example in the absence or, where appropriate, in the presence of a suitable solvent or diluent or a mixture thereof, the reactions being carried out, as required, with cooling, at room temperature or with heating, for example in a temperature range of from about −80° C. to the boiling point of the reaction medium, preferably from about −20° C. to about +150° C., and, if necessary, in a closed vessel, under pressure, in an inert gas atmosphere and/or under anhydrous conditions. Especially advantageous reaction conditions can be found in the Examples.

A leaving group such as, for example the leaving groups L₁ and L₂ defined hereinabove, or a counter-ion, is to be understood hereinabove and hereinbelow as being any removable group customarily considered for chemical reactions, as will be known to the person skilled in the art, especially OH, a halogen such as fluorine, chlorine, bromine or iodine, —O—Si(C₁-C₈alkyl)₃, —O-aryl, —S—(C₁-C₈alkyl), —S-aryl, —O—S(═O)₂U, —S(═O)U or —S(═O)₂U, wherein U is unsubstituted or substituted C₁-C₈alkyl, C₂-C₈alkenyl, C₂-C₈alkynyl, unsubstituted or substituted aryl or unsubstituted or substituted benzyl. Especially preferred leaving groups are chlorine or bromine, mesylate, triflate, tosylate, especially chlorine; and chloride or bromide, especially chloride.

Process (a): The reaction is carried out in acetic acid or a halohydrocarbon, such as dichloromethane, at a temperature from −20° C. to 100° C., preferably from 20° C. to 50° C. As oxidising agents there are used, for example, hydrogen peroxide, a peracid such as peracetic acid, trifluoroperacetic acid, 3-chloroperbenzoic acid or mixtures such as sodium perborate in acetic acid.

Process (b): The reaction is carried out preferably in an alcohol such as methanol, ethanol or an alcohol/water mixture, in the presence of an inorganic base such as NaOH or KOH and at a temperature of from 0° C. to 150° C., preferably from 20° C. to 80° C. Alternatively, aminolysis can be carried out using a primary amine such as n-butylamine in a hydrocarbon such as toluene or benzene at a temperature from 0° C. to 150° C., preferably from 20° C. to 80° C.

Process (c): Depending on the nature of the benzyl substituent to be cleaved off, it is possible, for example, to proceed under a hydrogen atmosphere, at a pressure of from 1 to 150 bar, especially from 1 to 20 bar, and with addition of a catalyst such as, for example, palladium-on-carbon, in an alcohol or ether. The preferred reaction temperature is from 0° C. to 120° C., especially from 20° C. to 80° C.

Processes (d) and (g): Preference is given to proceeding in the presence of a base such as potassium or sodium carbonate, in acetone or dimethylformamide, at a temperature of from 0° C. to 150° C., preferably from 20° C. to 80° C. Where appropriate, catalytic amounts of potassium iodide or sodium iodide, or phase-transfer catalysts such as crown ethers or quaternary ammonium salts, are added.

Process (e): Preference is given to proceeding in acetone, dichloromethane, acetic acid or, preferably water, where appropriate with addition of a mineral acid, at a temperature of from 0° C. to 120° C., preferably from 20° C. to 50° C. For complete cleavage of the acetal, a strong mineral acid such as, for example, hydrochloric acid, sulfuric acid or 4-toluenesulfonic acid is preferably added.

Process (f): The preparation of the difluoro-, dichloro-, dibromo-, chlorofluoro- and bromofluoro-vinyl compounds is carried out by reacting with CCl₄, CBr₄, CF₂X₂, CFX₃, CF₂XC(═O)ONa or CFX₂C(═O)ONa wherein X is bromine or chlorine, and in the presence of a trialkyl- or triaryl-phosphine, where appropriate with the addition of zinc powder. The procedure is carried out in an inert solvent such as, for example, benzene or toluene or an ether, such as diethyl ether, diisopropyl ether, dioxane or tetrahydrofuran, at a temperature of from 0° C. to 150° C., preferably from 20° C. to 80° C.

For the preparation of the dichlorovinyl compounds, the process can also be carried out in dimethylformamide, benzene, toluene or in an ether, at a temperature of from 0° C. to 120° C., preferably from 20° C. to 80° C., and in the presence of trichloroacetic acid/sodium trichloroacetate, then adding acetic anhydride, where appropriate with the addition of base such as, for example, triethylamine, and finally adding zinc and acetic acid.

Processes (h) and (k): Preference is given to proceeding in an ether, dimethyl-formamide, dimethyl acetamide or N-methylpyrrolidone, at a temperature of from 0° C. to 150° C., preferably from 20° C. to 80° C., with the addition of a base such as potassium or sodium carbonate. Alternatively, a coupling reagent such as, for example, azodicarboxylic acid diethyl or diisopropyl ester and triphenylphospine may be used. When W is oxygen and A₂ is C₁-C₆alkylene-, preference is given to proceeding using sodium hydride as base and in an inert solvent.

Processes (i) and (l):

When L₂ is a group Hal-C(═O)—, the process can be carried out in an inert solvent such as an ether or toluene, at from 0° C. to 80° C., and in the presence of a suitable base such as a trialkylamine.

In the other cases, the procedure is carried out in an ether, an amide such as dimethyl-formamide or N-methylpyrrolidone, and at from 0° C. to 150° C. As base, there may be used, for example, sodium hydride.

Processes (m), (n) and (o):

Preference is given to proceeding in a solvent such as, for example, tetrahydrofuran, toluene or dioxane, at a temperature of from 0° C. to 120° C., preferably from 0° C. to 80° C., with the addition of a base such as, for example, triethylamine.

Processes (p) and (q):

Preference is given to selection of the same solvents and working temperatures as in process (m). Preference is given to the addition of an acid such as, for example, toluene-sulfonic acid.

Process (r):

Preference is given to proceeding in water or a water/alcohol mixture, at a temperature of from 0° C. to 100° C., preferably from 20° C. to 80° C. For alkylation of the oxygen, the same conditions are selected as in process (d).

Compounds of formula (I) obtainable in accordance with the process or by another method can be converted in a manner known per se into different compounds of formula (I) by replacing one or more substituents of the starting compound of formula (I) by (an)other substituent(s) according to the invention in customary manner.

Depending upon the reaction conditions and starting materials selected as suitable in each case, it is possible in a reaction step to replace only one substituent by another substituent according to the invention or it is possible in the same reaction step to replace a plurality of substituents by other substituents according to the invention.

Salts of compounds of formula (I) can be prepared in a manner known per se. For example, salts of compounds of formula (I) with bases are obtained by treatment of the free compounds with a suitable base or a suitable ion exchange reagent.

Salts of compounds of formula (I) can be converted in customary manner into the free compounds of formula (I), for example by treatment with a suitable acid or a suitable ion exchange reagent.

Salts of compounds of formula (I) can be converted into different salts of compounds of formula (I) in a manner known per se.

The compounds of formula (I) in free form or in salt form may be in the form of one of the possible isomers or in the form of a mixture thereof, for example depending upon the number of asymmetric carbon atoms present in the molecule and the absolute and relative configuration thereof, and/or depending upon the configuration of non-aromatic double bonds present in the molecule, in the form of pure isomers, such as antipodes and/or diastereoisomers, or in the form of mixtures of isomers, such as mixtures of enantiomers, for example racemates, mixtures of diastereoisomers or mixtures of racemates. The invention relates both to the pure isomers and to all possible mixtures of isomers and this is to be understood accordingly hereinabove and hereinbelow, even when stereochemical details are not specifically mentioned in each case.

Mixtures of diastereoisomers, mixtures of racemates and mixtures of double-bond isomers of compounds of formula (I) in free form or in salt form obtainable in accordance with the process—depending upon the starting materials and procedures chosen—or by other means can be separated into the pure diastereoisomers or racemates in known manner on the basis of the physico-chemical differences between the constituents, for example by fractional crystallisation, distillation and/or chromatography.

Mixtures of enantiomers, such as racemates, so obtainable can be separated into the optical antipodes by known methods, for example by recrystallisation from an optically active solvent, by chromatography on chiral adsorbents, for example high-pressure liquid chromatography (HPLC) on acetyl cellulose, with the aid of suitable microorganisms, by cleavage with specific immobilised enzymes, or via the formation of inclusion compounds, for example using chiral crown ethers, in which case only one enantiomer is complexed, or by conversion into diastereoisomeric salts and separation of the diastereoisomer mixture thereby obtained, into the diastereoisomers, for example on the basis of their different solubilities by fractional crystallisation, from which the desired-enantiomer can be released by the action of suitable agents.

Pure diastereoisomers and enantiomers can be obtained not only by separation of corresponding mixtures of isomers but also, according to the invention, by generally known methods of diastereoselective or enantioselective synthesis, for example by carrying out the process according to the invention with starting materials that have appropriate stereo-chemistry.

It is advantageous to isolate or synthesise whichever isomer, for example enantiomer or diastereoisomer, or mixture of isomers, for example mixture of enantiomers or diastereoisomers, is biologically more active, insofar as the individual components have different biological activity.

The compounds of formula (I) in free form or in salt form may also be obtained in the form of their hydrates and/or may include other solvents, for example solvents which may optionally have been used for the crystallisation of compounds in solid form.

The invention relates to all those embodiments of the process according to which a compound obtainable as starting material or intermediate at any stage of the process is used as starting material and all or some of the remaining steps are carried out, or in which a starting material is used in the form of a derivative and/or a salt and/or its racemates or antipodes, or, especially, is formed under the reaction conditions.

In the process of the present invention it is preferable to use those starting materials and intermediates, in each case in free form or in salt form, which result in the compounds of formula (I) described hereinabove as being especially valuable, or salts thereof.

The invention relates especially to the preparation processes described in Examples P1 to P11.

The invention relates also to the intermediates of formulae (II) to (XXIX) and, where appropriate, their possible E/Z isomers, mixtures of E/Z isomers and/or tautomers, in each case in free form or in salt form, insofar as they are novel. The same preferences apply to those compounds as to the compounds of formula (I).

In the area of pest control, the compounds of formula (I) according to the invention are active ingredients exhibiting valuable preventive and/or curative activity with a very advantageous biocidal spectrum and a very broad spectrum, even at low rates of concentration, while being well tolerated by warm-blooded animals, fish and plants. They are, surprisingly, equally suitable for controlling both plant pests and ecto- and endo-parasites in humans and more especially in productive livestock, domestic animals and pets. They are effective against all or individual development stages of normally sensitive animal pests, but also of resistant animal pests, such as insects and representatives of the order Acarina, nematodes, cestodes and trematodes, while at the same time protecting useful organisms. The insecticidal or acaricidal activity of the active ingredients according to the invention may manifest itself directly, i.e. in the mortality of the pests, which occurs immediately or only after some time, for example during moulting, or indirectly, for example in reduced oviposition and/or hatching rate, good activity corresponding to a mortality of at least 50 to 60%.

Successful control within the scope of the subject of the invention is possible, in particular, of pests from the orders Lepidoptera, Coleoptera, Orthoptera, Isoptera, Psocoptera, Anoplura, Mallophaga, Thysanoptera, Heteroptera, Homoptera, Hymenoptera, Diptera, Siphonaptera, Thysanura and Acarina, mainly Acarina, Diptera, Thysanoptera, Lepidoptera and Coleoptera. Very especially good control is possible of the following pests:

Abagrotis spp., Abraxas spp., Acantholeucania spp., Acanthoplusia spp., Acarus spp., Acarus siro, Aceria spp., Aceria sheldoni, Acleris spp., Acoloithus spp., Acompsia spp., Acossus spp., Acria spp., Acrobasis spp., Acrocercops spp., Acrolepia spp., Acrolepiopsis spp., Acronicta spp., Acropolitis spp., Actebia spp., Aculus spp., Aculus schlechtendali, Adoxophyes spp., Adoxophyes reticulana, Aedes spp., Aegeria spp., Aethes spp., Agapeta spp., Agonopterix spp., Agriopis spp., Agriotes spp., Agriphila spp., Agrochola spp., Agroperina spp., Alabama ssp., Alabama argillaceae, Agrotis spp., Albuna spp., Alcathoe spp., Alcis spp., Aleimma spp., Aletia spp., Aleurothrixus spp., Aleurothrixus floccosus, Aleyrodes spp., Aleyrodes brassicae, Allophyes spp., Alsophila spp., Amata spp., Amathes spp., Amblyomma spp., Amblyptilia spp., Ammoconia spp., Amorbia spp., Amphion spp., Amphipoea spp., Amphipyra spp., Amyelois spp., Anacamptodes spp., Anagrapha spp., Anarsia spp., Anatrychyntis spp., Anavitrinella spp., Ancylis spp., Andropolia spp., Anhimella spp., Antheraea spp., Antherigona spp., Antherigona soccata, Anthonomus ssp., Anthonomus grandis, Anticarsia spp., Anticarsia gemmatalis, Aonidiella spp., Apamea spp., Aphania spp., Aphelia spp., Aphididae, Aphis spp., Apotomis spp., Aproaerema spp., Archippus spp., Archips spp., Acromyrmex, Arctia spp., Argas spp., Argolamprotes spp., Argyresthia spp., Argyrogramma spp., Argyroploce spp., Argyrotaenia spp., Arotrophora spp., Ascotis spp., Aspidiotus spp., Aspilapteryx spp., Asthenoptycha spp., Aterpia spp., Athetis spp., Atomaria spp., Atomaria linearis, Atta spp., Atypha spp., Autographa spp., Axylia spp., Bactra spp., Barbara spp., Batrachedra spp., Battaristis spp., Bembecia spp., Bemisia spp., Bemisia tabaci, Bibio spp., Bibio hortulanis, Bisigna spp., Blastesthia spp., Blatta spp., Blatella spp., Blepharosis spp., Bleptina spp., Boarmia spp., Bombyx spp., Bomolocha spp., Boophilus spp., Brachmia spp., Bradina spp., Brevipalpus spp., Brithys spp., Bryobia spp., Bryobia praetiosa, Bryotropha spp., Bupalus spp., Busseola spp., Busseola fusca, Cabera spp., Cacoecimorpha spp., Cadra spp., Cadra cautella, Caenurgina spp., Calipitrimerus spp., Callierges spp., Callophpora spp., Callophpora erythrocephala, Calophasia spp., Caloptilia spp., Calybites spp., Capnoptycha spp., Capua spp., Caradrina spp., Caripeta spp., Carmenta spp., Carposina spp., Carposina nipponensis, Catamacta spp., Catelaphris spp., Catoptria spp., Caustoloma spp., Celaena spp., Celypha spp., Cenopis spp., Cephus spp., Ceramica spp., Cerapteryx spp., Ceratitis spp, Ceratophyllus spp., Ceroplaster spp., Chaetocnema spp., Chaetocnema tibialis, Chamaesphecia spp., Charanvca spp., Cheimophila spp., Chersotis spp., Chiasmia spp., Chilo spp., Chionodes spp., Chorioptes spp., Choristoneura spp., Chrysaspidia spp., Chrysodeixis spp., Chrysomya spp., Chrysomphalus spp., Chrysomphalus dictyospermi, Chrysomphalus aonidium, Chrysoteuchia spp., Cilix spp., Cimex spp., Clysia spp., Clysia ambiguella, Clepsis spp., Cnaemidophorus spp., Cnaphalocrocis spp., Cnephasia spp., Coccus spp., Coccus hesperidum, Cochylis spp., Coleophora spp., Colotois spp., Commophila spp., Conistra spp., Conopomorpha spp., Corcyra spp., Cornutiplusia spp., Cosmia spp., Cosmopolites spp., Cosmopterix spp., Cossus spp., Costaeonvexa spp., Crambus spp., Creatonotos spp., Crocidolomia spp., Crocidolomia binotalis, Croesia spp., Crymodes spp., Cryptaspasma spp., Cryptoblabes spp., Cryptocala spp., Cryptophlebia spp., Cryptophlebia leucotreta, Cryptoptila spp., Ctenopseustis spp., Ctenocephalides spp., Cucullia spp., Curculio spp., Culex spp., Cuterebra spp., Cydia spp., Cydia pomonella, Cymbalophora spp., Dactylethra spp., Dacus spp., Dadica spp., Damalinea spp., Dasychira spp., Decadarchis spp., Decodes spp., Deilephila spp., Deltodes spp., Dendrolimus spp., Depressaria spp., Dermestes spp., Dermanyssus spp., Dermanyssus gallinae, Diabrotica spp., Diachrysia spp., Diaphania spp., Diarsia spp., Diasemia spp., Diatraea spp., Diceratura spp., Dichomeris spp., Dichrocrocis spp., Dichrorampha spp., Dicycla spp., Dioryctria spp., Diparopsis spp., Diparopsis castanea, Dipleurina spp., Diprion spp., Diprionidae, Discestra spp., Distantiella spp., Distantiella theobroma, Ditula spp., Diurnea spp., Doratopteryx spp., Drepana spp., Drosphila spp., Drosphila melanogaster, Dysauxes spp., Dysdercus spp., Dysstroma spp., Eana spp., Earias spp., Ecclitica spp., Ecdytolopha spp., Ecpyrrhorrhoe spp., Ectomyelois spp., Eetropis spp., Egira spp., Elasmopalpus spp., Emmelia spp., mpoasca spp., Empyreuma spp., Enargia spp., Enarmonia spp., Endopiza spp., Endothenia spp., Endotricha spp., Eoreuma spp., Eotetranychus spp., Eotetranychus carpini, Epagoge spp., Epelis spp., Ephestia spp., Ephestiodes spp., Epiblema spp., Epiehoristodes spp., Epinotia spp., Epiphyas spp., Epiplema spp., Epipsestis spp., Epirrhoe spp., Episimus spp., Epitymbia spp., Epilachna spp., Erannis spp., Erastria spp., Eremnus spp., Ereunetis spp., Eriophyes spp., Eriosoma spp., Eriosoma lanigerum, Erythroneura spp., Estigmene spp., Ethmia spp., Etiella spp., Euagrotis spp., Eucosma spp., Euehlaena spp., Euelidia spp., Eueosma spp., Euchistus spp., Eucosmomorpha spp., Eudonia spp., Eufidonia spp., Euhyponomeutoides spp., Eulepitodes spp., Eulia spp., Eulithis spp., Eupithecia spp., Euplexia spp., Eupoecilia spp., Eupoecilia ambiguella, Euproctis spp., Eupsilia spp., Eurhodope spp., Eurois spp., Eurygaster spp., Eurythmia spp., Eustrotia spp., Euxoa spp., Euzophera spp., Evergestis spp., Evippe spp., Exartema spp., Fannia spp., Faronta spp., Feltia spp., Filatima spp., Fishia spp., Franklinielia spp., Fumibotys spp., Gaesa spp., Gasgardia spp., Gastrophilus spp., Gelechia spp., Gilpinia spp., Gilpinia polytoma, Glossina spp., Glyphipterix spp., Glyphodes spp., Gnorimoschemini spp., Gonodonta spp., Gortyna spp., Gracillaria spp., Graphania spp., Grapholita spp., Grapholitha spp., Gravitarmata spp., Gretchena spp., Griselda spp., Gryllotalpa spp., Gynaephora spp., Gypsonoma spp., Hada spp., Haematopinus spp., Halisidota spp., Harpipteryx spp., Harrisina spp., Hedya spp., Helicoverpa spp., Heliophobus spp., Heliothis spp., Hellula spp., Helotropa spp., Hemaris spp., Hercinothrips spp., Herculia spp., Hermonassa spp., Heterogenea spp., Holomelina spp., Homadaula spp., Homoeosoma spp., Homoglaea spp., Homohadena spp., Homona spp., Homonopsis spp., Hoplocampa spp., Hoplodrina spp., Hoshinoa spp., Hxalomma spp., Hydraecia spp., Hydriomena spp., Hyles spp., Hyloicus spp., Hypagyrtis spp., Hypatima spp., Hyphantria spp., Hyphantria cunea, Hypocala spp., Hypocoena spp., Hypodema spp., Hyppobosca spp., Hypsipyla spp., Hyssia spp., Hysterosia spp., Idaea spp., Idia spp., Ipimorpha spp., Isia spp., Isochorista spp., Isophrictis spp., Isopolia spp., Isotrias spp., Ixodes spp., Itame spp., Jodia spp., Jodis spp., Kawabea spp., Keiferia spp., Keiferia lycopersicella, Labdia spp., Lacinipolia spp., Lambdina spp., Lamprothritpa spp., Laodelphax spp., Lasius spp., Laspeyresia spp., Leptinotarsa spp., Leptinotarsa decemlineata, Leptocorisa spp., Leptostales spp., Lecanium spp., Lecanium comi, Lepidosaphes spp., Lepisma spp., Lepisma saccharina, Lesmone spp., Leucania spp., Leucinodes spp., Leucophaea spp., Leucophaea maderae, Leucoptera spp., Leucoptera scitella, Linognathus spp., Liposcelis spp., Lissorhoptrus spp., Lithacodia spp., Lithocolletis spp., Lithomoia spp., Lithophane spp., Lixodessa spp., Lobesia spp., Lobesia botrana, Lobophora spp., Locusta spp., Lomanaltes spp., Lomographa spp., Loxagrotis spp., Loxostege spp., Lucilia spp., Lymantria spp., Lymnaecia spp., Lyonetia spp., Lyriomyza spp., Macdonnoughia spp., Macrauzata spp., Macronoctua spp., Macrosiphus spp., Malacosoma spp., Maliarpha spp., Mamestra spp., Mamestra brassicae, Manduca spp., Manduca sexta, Marasmia spp., Margaritia spp., Matratinea spp., Matsumuraeses spp., Melanagromyza spp., Melipotes spp., Melissopus spp., Melittia spp., Melolontha spp., Meristis spp., Meritastis spp., Merophyas spp., Mesapamea spp., Mesogona spp., Mesoleuca spp., Metanema spp., Metendothenia spp., Metzneria spp., Micardia spp., Microcorses spp., Microleon spp., Mnesictena spp., Mocis spp., Monima spp., Monochroa spp., Monomorium spp., Monomorium pharaonis, Monopsis spp., Morrisonia spp., Musca spp., Mutuuraia spp., Myelois spp., Mythimna spp., Myzus spp., Naranga spp., Nedra spp., Nemapogon spp., Neodiprion spp., Neosphaleroptera spp., Nephelodes spp., Nephotettix spp., Nezara spp., Nilaparvata spp., Niphonympha spp., Nippoptilia spp., Noctua spp., Nola spp., Notocelia spp., Notodonta spp., Nudaurelia spp., Ochropleura spp., Ocnerostoma spp., Oestrus spp., Olethreutes spp., Oligia spp., Olindia spp., Olygonychus spp., Olygonychus gallinae, Oncocnemis spp., Operophtera spp., Ophisma spp., Opogona spp., Oraesia spp., Orniodoros spp., Orgyia spp., Oria spp., Orseolia spp., Orthodes spp., Orthogonia spp., Orthosia spp., Oryzaephilus spp., Oscinella spp., Oscinella frit, Osminia spp., Ostrinia spp., Ostrinia nubilalis, Otiorhynchus spp., Ourapteryx spp., Pachetra spp., Pachysphinx spp., Pagyda spp., Paleacrita spp., Paliga spp., Palthis spp., Pammene spp., Pandemis spp., Panemeria spp., Panolis spp., Panolis flammea, Panonychus spp., Parargyresthia spp., Paradiarsia spp., Paralobesia spp., Paranthrene spp., Parapandemis spp., Parapediasia spp., Parastichtis spp., Parasyndemis spp., Paratoria spp., Pareromeme spp., Pectinophora spp., Pectinophora gossypiella, Pediculus spp., Pegomyia spp., Pegomyia hyoscyami, Pelochrista spp., Pennisetia spp., Penstemonia spp., Pemphigus spp., Peribatodes spp., Peridroma spp., Perileucoptera spp., Periplaneta spp., Perizoma spp., Petrova spp., Pexicopia spp., Phalonia spp., Phalonidia spp., Phaneta spp., Phlyctaenia spp., Phlyctinus spp., Phorbia spp., Phragmatobia spp., Phricanthes spp., Phthorimaea spp., Phthorimaea operculella, Phyllocnistis spp., Phyllocoptruta spp., Phyllocoptruta oleivora, Phyllonorycter spp., Phyllophila spp., Phylloxera spp., Pieris spp., Pieris rapae, Piesma spp., Planococus spp., Planotortrix spp., Platyedra spp., Platynota spp., Platyptilia spp., Platysenta spp., Plodia spp., Plusia spp., Plutella spp., Plutella xylostella, Podosesia spp., Polia spp., Popillia spp., Polymixis spp., Polyphagotarsonemus spp., Polyphagotarsonemus latus, Prays spp., Prionoxystus spp., Probole spp., Proceras spp., Prochoerodes spp., Proeulia spp., Proschistis spp., Proselena spp., Proserpinus spp., Protagrotis spp., Proteoteras spp., Protobathra spp., Protoschinia spp., Pselnophorus spp., Pseudaletia spp., Pseudanthonomus spp., Pseudaternelia spp., Pseudaulacaspis spp., Pseudexentera spp., Pseudococus spp., Pseudohermenias spp., Pseudoplusia spp., Psoroptes spp., Psylla spp., Psylliodes spp., Pterophorus spp., Ptycholoma spp., Pulvinaria spp., Pulvinaria aethiopica, Pyralis spp., Pyrausta spp., Pyrgotis spp., Pyrreterra spp., Pyrrharctia spp., Quadraspidiotus spp., Rancora spp., Raphia spp., Reticultermes spp., Retinia spp., Rhagoletis spp, Rhagoletis pomonella, Rhipicephalus spp., Rhizoglyphus spp., Rhizopertha spp., Rhodnius spp., Rhophalosiphum spp., Rhopobota spp., Rhyacia spp., Rhyacionia spp., Rhynchopacha spp., Rhyzosthenes spp., Rivula spp., Rondotia spp., Rusidrina spp., Rynchaglaea spp., Sabulodes spp., Sahlbergella spp., Sahlbergella singularis, Saissetia spp., Samia spp., Sannina spp., Sanninoidea spp., Saphoideus spp., Sarcoptes spp., Sathrobrota spp., Scarabeidae, Sceliodes spp., Schinia spp., Schistocerca spp., Schizaphis spp., Schizura spp., Schreckensteinia spp., Sciara spp., Scirpophaga spp., Scirthrips auranti, Scoparia spp., Scopula spp., Scotia spp., Scotinophara spp., Scotogramma spp., Scrobipalpa spp., Scrobipalpopsis spp., Semiothisa spp., Sereda spp., Sesamia spp., Sesia spp., Sicya spp., Sideridis spp., Simyra spp., Sineugraphe spp., Sitochroa spp., Sitobion spp., Sitophilus spp., Sitotroga spp., Solenopsis spp., Smerinthus spp., Sophronia spp., Spaelotis spp., Spargaloma spp., Sparganothis spp., Spatalistis spp., Sperchia spp., Sphecia spp., Sphinx spp., Spilonota spp., Spodoptera spp., Spodoptera littoralis, Stagmatophora spp., Staphylinochrous spp., Stathmopoda spp., Stenodes spp., Sterrha spp., Stomoxys spp., Strophedra spp., Sunira spp., Sutyna spp., Swammerdamia spp., Syllomatia spp., Sympistis spp., Synanthedon spp., Synaxis spp., Syncopacma spp., Syndemis spp., Syngrapha spp., Synthomeida spp., Tabanus spp., Taeniarchis spp., Taeniothrips spp., Tannia spp., Tarsonemus spp., Tegulifera spp., Tehama spp., Teleiodes spp., Telorta spp., Tenebrio spp., Tephrina spp., Teratoglaea spp., Terricula spp., Tethea spp., Tetranychus spp., Thalpophila spp., Thaumetopoea spp., Thiodia spp., Thrips spp., Thrips palmi, Thrips tabaci, Thyridopteryx spp., Thyris spp., Tineola spp., Tipula spp., Tortricidia spp., Tortrix spp., Trachea spp., Trialeurodes spp., Trialeurodes vaporariorum, Triatoma spp., Triaxomera spp., Tribolium spp., Tricodectes spp., Trichoplusia spp., Trichoplusia ni, Trichoptilus spp., Trioza spp., Trioza erytreae, Triphaenia spp., Triphosa spp., Trogoderma spp., Tyria spp., Udea spp., Unaspis spp., Unaspis citri, Utetheisa spp., Valeriodes spp., Vespa spp., Vespamima spp., Vitacea spp., Vitula spp., Witlesia spp., Xanthia spp., Xanthorhoe spp., Xanthotype spp., Xenomicta spp., Xenopsylla spp., Xenopsylla cheopsis, Xestia spp., Xylena spp., Xylomyges spp., Xyrosaris spp., Yponomeuta spp., Ypsolopha spp., Zale spp., Zanclognathus spp., Zeiraphera spp., Zenodoxus spp., Zeuzera spp., Zygaena spp.,

It is also possible to control pests of the class Nematoda using the compounds according to the invention. Such pests include, for example,
root knot nematodes, cyst-forming nematodes and also stem and leaf nematodes;
especially of Heterodera spp., e.g. Heterodera schachtii, Heterodora avenae and Heterodora trifolii; Globodera spp., e.g. Globodera rostochiensis; Meloidogyne spp., e.g. Meloidogyne incognita and Meloidogyne javanica; Radopholus spp., e.g. Radopholus similis; Pratylenchus, e.g. Pratylenchus neglectans and Pratylenchus penetrans; Tylenchulus, e.g. Tylenchulus semipenetrans; Longidorus, Trichodorus, Xiphinema, Ditylenchus, Apheenchoides and Anguina; especially Meloidogyne, e.g. Meloidogyne incognita, and Heterodera, e.g. Heterodera glycines.

An especially important aspect of the present invention is the use of the compounds of formula (I) according to the invention in the protection of plants against parasitic feeding pests.

The action of the compounds according to the invention and the compositions comprising them against animal pests can be significantly broadened and adapted to the given circumstances by the addition of other insecticides, acaricides or nematicides. Suitable additives include, for example, representatives of the following classes of active ingredient: organophosphorus compounds, nitrophenols and derivatives, formamidines, ureas, carbamates, pyrethroids, chlorinated hydrocarbons, neonicotinoids and Bacillus thuringiensis preparations.

Examples of especially suitable mixing partners include: azamethiphos; chlorfenvinphos; cypermethrin, cypermethrin high-cis; cyromazine; diafenthiuron; diazinon; dichlorvos; dicrotophos; dicyclanil; fenoxycarb; fluazuron; furathiocarb; isazofos; iodfenphos; kinoprene; lufenuron; methacriphos; methidathion; monocrotophos; phosphamidon; profenofos; diofenolan; a compound obtainable from the Bacillus thuringiensis strain GC91 or from strain NCTC11821; pymetrozine; bromopropylate; methoprene; disulfoton; quinalphos; taufluvalinate; thiocyclam; thiometon; aldicarb; azinphos-methyl; benfuracarb; bifenthrin; buprofezin; carbofuran; dibutylaminothio; cartap; chlorfluazuron; chlorpyrifos; clothianidin; cyfluthrin; lambda-cyhalothrin; alpha-cypermethrin; zeta-cypermethrin; deltamethrin; diflubenzuron; endosulfan; ethiofencarb; fenitrothion; fenobucarb; fenvalerate; formothion; methiocarb; heptenophos; imidacloprid; isoprocarb; methamidophos; methomyl; mevinphos; parathion; parathion-methyl; phosalone; pirimicarb; propoxur; teflubenzuron; terbufos; triazamate; fenobucarb; tebufenozide; fipronil; beta-cyfluthrin; silafluofen; fenpyroximate; pyridaben; pyridalyl; fenazaquin; pyriproxyfen; pyrimidifen; nitenpyram; acetamiprid; emamectin; emamectin-benzoate; spinosad; a plant extract that is active against insects; a preparation that comprises nematodes and is active against insects; a preparation obtainable from Bacillus subtilis; a preparation that comprises fungi and is active against insects; a preparation that comprises viruses and is active against insects; chlorfenapyr; acephate; acrinathrin; alanycarb; alphamethrin; amitraz; AZ 60541; azinphos A; azinphos M; azocyclotin; bendiocarb; bensultap; beta-cyfluthrin; brofenprox; bromophos A; bufencarb; butocarboxin; butylpyridaben; cadusafos; carbaryl; carbophenothion; chloethocarb; chlorethoxyfos; chlormephos; cis-resmethrin; clocythrin; clofentezine; cyanophos; cycloprothrin; cyhexatin; demeton M; demeton S; demeton-5-methyl; dichlofenthion; dicliphos; diethion; dimethoate; dimethylvinphos; dioxathion; edifenphos; esfenvalerate; ethion; ethofenprox; ethoprophos; etrimphos; fenamiphos; fenbutatin oxide; fenothiocarb; fenpropathrin; fenpyrad; fenthion; fluazinam; flucycloxuron; flucythrinate; flufenoxuron; flufenprox; fonophos; fosthiazate; fubfenprox; HCH; hexaflumuron; hexythiazox; flonicamid; iprobenfos; isofenphos; isoxathion; ivermectin; malathion; mecarbam; mesulfenphos; metaldehyde; metolcarb; milbemectin; moxidectin; naled; NC 184; nithiazine; omethoate; oxamyl; oxydemethon M; oxydeprofos; permethrin; phenthoate; phorate; phosmet; phoxim; pirimiphos M; pirimiphos E; promecarb; propaphos; prothiofos; prothoate; pyrachlophos; pyradaphenthion; pyresmethrin; pyrethrum; tebufenozide; salithion; sebufos; sulfotep; sulprofos; tebufenpyrad; tebupirimphos; tefluthrin; temephos; terbam; tetrachlorvinphos; thiacloprid; thiafenox; thiamethoxam; thiodicarb; thiofanox; thionazin; thuringiensin; tralomethrin; triarathene; triazophos; triazuron; trichlorfon; triflumuron; trimethacarb; vamidothion; xylylcarb; etoxazole; zetamethrin; indoxacarb; methoxyfenozide; bifenazate; XMC (3,5-xylyl methylcarbamate); or the fungus pathogen Metarhizium anisopliae.

The compounds according to the invention can be used to control, i.e. to inhibit or destroy, pests of the mentioned type occurring on plants, especially on useful plants and ornamentals in agriculture, in horticulture and in forestry, or on parts of such plants, such as the fruits, blossoms, leaves, stems, tubers or roots, while in some cases plant parts that grow later are still protected against those pests.

Target crops include especially cereals, such as wheat, barley, rye, oats, rice, maize and sorghum; beet, such as sugar beet and fodder beet; fruit, e.g. pomes, stone fruit and soft fruit, such as apples, pears, plums, peaches, almonds, cherries and berries, e.g. strawberries, raspberries and blackberries; leguminous plants, such as beans, lentils, peas and soybeans; oil plants, such as rape, mustard, poppy, olives, sunflowers, coconut, castor oil, cocoa and groundnuts; cucurbitaceae, such as marrows, cucumbers and melons; fibre plants, such as cotton, flax, hemp and jute; citrus fruits, such as oranges, lemons, grapefruit and mandarins; vegetables, such as spinach, lettuce, asparagus, cabbages, carrots, onions, tomatoes, potatoes and paprika; lauraceae, such as avocado, cinnamon and camphor; and tobacco, nuts, coffee, aubergines, sugar cane, tea, pepper, vines, hops, bananas, natural rubber plants and ornamentals.

Further areas of use of the compounds according to the invention are the protection of stored goods and storerooms and the protection of raw materials, and also in the hygiene sector, especially the protection of domestic animals and productive livestock against pests of the mentioned type, more especially the protection of domestic animals, especially cats and dogs, from infestation by fleas, ticks and nematodes.

The invention therefore relates also to pesticidal compositions, such as emulsifiable concentrates, suspension concentrates, directly sprayable or dilutable solutions, spreadable pastes, dilute emulsions, wettable powders, soluble powders, dispersible powders, wettable powders, dusts, granules and encapsulations of polymer substances, that comprise at least one of the compounds according to the invention, the choice of formulation being made in accordance with the intended objectives and the prevailing circumstances.

The active ingredient is used in those compositions in pure form, a solid active ingredient, for example, in a specific particle size, or preferably together with at least one of the adjuvants customary in formulation technology, such as extenders, e.g. solvents or solid carriers, or surface-active compounds (surfactants). In the area of parasite control in humans, domestic animals, productive livestock and pets it will be self-evident that only physiologically tolerable additives are used.

Solvents are, for example: non-hydrogenated or partly hydrogenated aromatic hydrocarbons, preferably fractions C₈ to C₁₂ of alkylbenzenes, such as xylene mixtures, alkylated naphthalenes or tetrahydronaphthalene, aliphatic or cycloaliphatic hydrocarbons, such as paraffins or cyclohexane, alcohols, such as ethanol, propanol or butanol, glycols and ethers and esters thereof, such as propylene glycol, dipropylene glycol ether, ethylene glycol or ethylene glycol monomethyl or -ethyl ether, ketones, such as cyclohexanone, isophorone or diacetone alcohol, strongly polar solvents, such as N-methylpyrrolid-2-one, dimethyl sulfoxide or N,N-dimethylformamide, water, non-epoxidized or epoxidized plant oils, such as non-epoxidized or epoxidized rapeseed, castor, coconut or soya oil, and silicone oils.

The solid carriers used, for example for dusts and dispersible powders, are as a rule natural rock powders, such as calcite, talc, kaolin, montmorillonite or attapulgite. Highly disperse silicic acids or highly disperse absorbent polymers can also be added to improve the physical properties. Granular adsorptive granule carriers are porous types, such as pumice, crushed brick, sepiolite or bentonite, and non-sorbent carrier materials are calcite or sand. A large number of granular materials of inorganic or organic nature can furthermore be used, in particular dolomite or comminuted plant residues.

Surface-active compounds are, depending on the nature of the active compound to be formulated, nonionic, cationic and/or anionic surfactants or surfactant mixtures with good emulsifying, dispersing and wetting properties. The surfactants listed below are to be regarded only as examples; many other surfactants which are customary in formulation technology and are suitable according to the invention are described in the relevant literature.

Nonionic surfactants are, in particular, polyglycol ether derivatives of aliphatic or cycloaliphatic alcohols, saturated or unsaturated fatty acids and alkylphenols, which can contain 3 to 30 glycol ether groups and 8 to 20 carbon atoms in the (aliphatic) hydrocarbon radical and 6 to 18 carbon atoms in the alkyl radical of the alkylphenols. Substances which are furthermore suitable are water-soluble polyethylene oxide adducts, containing 20 to 250 ethylene glycol ether and 10 to 100 propylene glycol ether groups, on propylene glycol, ethylene diaminopolypropylene glycol and alkyl polypropylene glycol having 1 to 10 carbon atoms in the alkyl chain. The compounds mentioned usually contain 1 to 5 ethylene glycol units per propylene glycol unit. Examples are nonylphenol-polyethoxyethanols, castor oil polyglycol ethers, polypropylene-polyethylene oxide adducts, tributylphenoxypolyethoxyethanol, polyethylene glycol and octylphenoxypolyethoxyethanol. Other substances are fatty acid esters of polyoxyethylene sorbitan, such as polyoxyethylene sorbitan trioleate.

The cationic surfactants are, in particular, quaternary ammonium salts which contain, as substituents, at least one alkyl radical having 8 to 22 C atoms and, as further substituents, lower, non-halogenated or halogenated alkyl, benzyl or lower hydroxyalkyl radicals. The salts are preferably in the form of halides, methyl-sulfates or ethyl-sulfates. Examples are stearyl-trimethyl-ammonium chloride and benzyl-di-(2-chloroethyl)-ethyl-ammonium bromide.

Suitable anionic surfactants can be both water-soluble soaps and water-soluble synthetic surface-active compounds. Suitable soaps are the alkali metal, alkaline earth metal and substituted or unsubstituted ammonium salts of higher fatty acids (C₁₀-C₂₂), such as the sodium or potassium salts of oleic or stearic acid, or of naturally occurring fatty acid mixtures, which can be obtained, for example, from coconut oil or tall oil; and furthermore also the fatty acid methyl-taurine salts. However, synthetic surfactants are more frequently used, in particular fatty sulfonates, fatty sulfates, sulfonated benzimidazole derivatives or alkylarylsulfonates. The fatty sulfonates and sulfates are as a rule in the form of alkali metal, alkaline earth metal or substituted or unsubstituted ammonium salts and in general have an alkyl radical of 8 to 22 C atoms, alkyl also including the alkyl moiety of acyl radicals; examples are the sodium or calcium salt of ligninsulfonic acid, of dodecylsulfuric acid ester or of a fatty alcohol sulfate mixture prepared from naturally occurring fatty acids. These also include the salts of sulfuric acid esters and sulfonic acids of fatty alcohol-ethylene oxide adducts. The sulfonated benzimidazole derivatives preferably contain 2 sulfonic acid groups and a fatty acid radical having about 8 to 22 C atoms. Alkylarylsulfonates are, for example, the sodium, calcium or triethanolammonium salts of dodecylbenzenesulfonic acid, of dibutyinaphthalenesulfonic acid or of a naphthalenesulfonic acid-formaldehyde condensation product. Corresponding phosphates, such as salts of the phosphoric acid ester of a p-nonylphenol-(4-14)-ethylene oxide adduct or phospholipids, can further also be used.

The compositions as a rule comprise 0.1 to 99%, in particular 0.1 to 95%, of active compound and 1 to 99.9%, in particular 5 to 99.9%, of—at least—one solid or liquid auxiliary, it being possible as a rule for 0 to 25%, in particular 0.1 to 20%, of the composition to be surfactants (% is in each case percent by weight). While concentrated compositions are more preferred as commercial goods, the end user as a rule uses dilute compositions which comprise considerably lower concentrations of active compound. Preferred compositions are composed, in particular, as follows (%=percent by weight):

Emulsifiable Concentrates:

| | |
|---|---|
| active ingredient: | 1 to 90%, preferably 5 to 20% |
| surfactant: | 1 to 30%, preferably 10 to 20% |
| solvent: | 5 to 98%, preferably 70 to 85% |

Dusts:

| | |
|---|---|
| active ingredient: | 0.1 to 10%, preferably 0.1 to 1% |
| solid carrier: | 99.9 to 90%, preferably 99.9 to 99% |

Suspension Concentrates:

| | |
|---|---|
| active ingredient: | 5 to 75%, preferably 10 to 50% |
| water: | 94 to 24%, preferably 88 to 30% |
| surfactant: | 1 to 40%, preferably 2 to 30% |

Wettable Powders:

| | |
|---|---|
| active ingredient: | 0.5 to 90%, preferably 1 to 80% |
| surfactant: | 0.5 to 20%, preferably 1 to 15% |
| solid carrier: | 5 to 99%, preferably 15 to 98% |

Granules:

| | |
|---|---|
| active ingredient: | 0.5 to 30%, preferably 3 to 15% |
| solid carrier: | 99.5 to 70%, preferably 97 to 85% |

The compositions according to the invention may also comprise further solid or liquid adjuvants, such as stabilisers, e.g. vegetable oils or epoxidised vegetable oils (e.g. epoxidised coconut oil, rapeseed oil or soybean oil), antifoams, e.g. silicone oil, preservatives, viscosity regulators, binders and/or tackifiers as well as fertilisers or other active ingredients for obtaining special effects, e.g. acaricides, bactericides, fungicides, nematicides, molluscicides or selective herbicides.

The crop protection products according to the invention are prepared in known manner, in the absence of adjuvants, e.g. by grinding, sieving and/or compressing a solid active ingredient or mixture of active ingredients, for example to a certain particle size, and in the presence of at least one adjuvant, for example by intimately mixing and/or grinding the active ingredient or mixture of active ingredients with the adjuvant(s). The invention relates likewise to those processes for the preparation of the compositions according to the invention and to the use of the compounds of formula (I) in the preparation of those compositions.

The invention relates also to the methods of application of the crop protection products, i.e. the methods of controlling pests of the mentioned type, such as spraying, atomising, dusting, coating, dressing, scattering or pouring, which are selected in accordance with the intended objectives and the prevailing circumstances, and to the use of the compositions for controlling pests of the mentioned type. Typical rates of concentration are from 0.1 to 1000 ppm, preferably from 0.1 to 500 ppm, of active ingredient. The rates of application per hectare are generally from 1 to 2000 g of active ingredient per hectare, especially from 10 to 1000 g/ha, preferably from 20 to 600 g/ha.

A preferred method of application in the area of crop protection is application to the foliage of the plants (foliar application), the frequency and the rate of application being dependent upon the risk of infestation by the pest in question. However, the active ingredient can also penetrate the plants through the roots (systemic action) when the locus of the plants is impregnated with a liquid formulation or when the active ingredient is incorporated in solid form into the locus of the plants, for example into the soil, e.g. in granular form (soil application). In the case of paddy rice crops, such granules may be applied in metered amounts to the flooded rice field.

The crop protection products according to the invention are also suitable for protecting plant propagation material, e.g. seed, such as fruits, tubers or grains, or plant cuttings, against animal pests. The propagation material can be treated with the composition before planting: seed, for example, can be dressed before being sown. The active ingredients according to the invention can also be applied to grains (coating), either by impregnating the seeds in a liquid formulation or by coating them with a solid formulation. The composition can also be applied to the planting site when the propagation material is being planted, for example to the seed furrow during sowing. The invention relates also to such methods of treating plant propagation material and to the plant propagation material so treated.

The following Examples serve to illustrate the invention. They do not limit the invention. Temperatures are in degrees Celsius; mixing ratios of solvents are given in parts by volume. In the data relating to NMR spectra, DMSO denotes dimethyl sulfoxide, s denotes singlet, t denotes triplet, d denotes doublet, q denotes quartet and m denotes multiplet.

### PREPARATION EXAMPLES

### Example P1

### Preparation of 4-{2-[2,6-dichloro-4-(3,3-dichloroallyloxy)-benzyloxy]-ethoxy}-2-trifluoromethyl-pyridine of formula

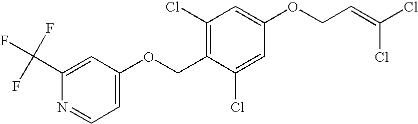

1) 13.5 g of sodium hydroxide are dissolved in 40 ml of water. 50 g of 3,5-dichlorophenol are introduced and the mixture is heated to 45°. At that temperature, 70 ml of 36.5% aqueous formaldehyde solution are added dropwise over 18 hours. Then, at room temperature, 350 ml of water are added and acidification with acetic acid is carried out. The crude product that precipitates out is filtered off, dissolved in ethyl acetate, washed with water and dried. After purification over silica gel, 4-hydroxymethyl-3,5-dichlorophenol is obtained. ¹H NMR (DMSO) 300 MHz: 7.0 (s,2H), 5.1 (t,1H), 4.7 (d,2H).

2) 18 g of 4-hydroxymethyl-3,5-dichlorophenol are dissolved in 600 ml of acetone. 19.3 g of potassium carbonate and a spatula tip of potassium iodide are added thereto. 18.8 ml of 1,1,1,3-tetrachloropropane are added to the suspension dropwise. After stirring at 50° for 30 hours to complete the reaction, cooling, filtration and concentration are carried out. The crude product is dissolved in ethyl acetate, washed with dilute hydrochloric acid and water and dried. After purification over silica gel, there is obtained [2,6-dichloro-4-(3,3-dichloroallyloxy)-phenyl]-methanol of formula

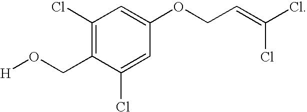

¹H NMR (DMSO) 300 MHz: 7.1 (s,2H), 6.4 (t,1H), 5.0 (t,1H), 4.7 (d,2H), 4.5 (d,2H).

3) At 0° C., 44 μl of azodicarboxylic acid diisopropyl ester are added to 54 mg of triphenylphospine in 1 ml of toluene. After 40 minutes, a solution of 50 mg of [2,6-dichloro-4-(3,3-dichloroallyloxy)-phenyl]-methanol and 30 mg of 4-hydroxy-2-trifluoromethyl-pyridine in 2 ml of toluene is added dropwise. After 45 minutes at 0° C. and 18 hours at room temperature, the reaction mixture is concentrated. After purification over silica gel, the title compound (compound 1.14) is obtained.

### Example P2

### Preparation of 4-[2,6-dichloro-4-(3,3-dichloroallyloxy)-benzyloxymethyl]-2-(4-trifluoromethoxyphenyl)-[1,3]dioxolane of formula

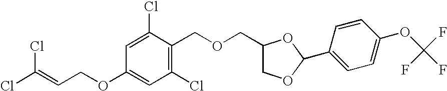

1) At room temperature and under a nitrogen atmosphere, 3.01 g of [2,6-dichloro-4-(3,3-dichloroallyloxy)-phenyl]-methanol are dissolved in 17 ml of dimethylformamide. 3.81 g of triphenylphosphine and then 3.65 g of tetrabromomethane are then added thereto. After 2 hours, 10 ml of saturated sodium hydrogen carbonate solution are added dropwise. The reaction mixture is poured into water and the crude product is extracted with ethyl acetate. After purification over silica gel, there is obtained 2-bromomethyl-1,3-dichloro-5-(3,3-di-chloroallyloxy)-benzene of formula

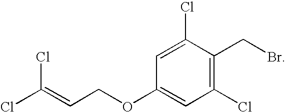

¹H NMR (300 MHz) CDCl₃: 6.7 (s, 2H), 5.95 (t, 1H), 4.55 (s, 2H), 4.45 (d, 2H).

2) At room temperature and under a nitrogen atmosphere, 520 mg of sodium hydride (55%) are suspended in 15 ml of tetrahydrofuran. 1.65 g of DL-isopropylideneglycerol dissolved in 3 ml of tetrahydrofuran are then added dropwise thereto. After 30 minutes, 2.89 g of 2-bromomethyl-1,3-dichloro-5-(3,3-dichloroallyloxy)-benzene, dissolved in 5 ml of tetrahydrofuran, are added. After 3.5 hours, 3 ml of water are added first and then 20 ml of saturated sodium chloride solution. The crude product is extracted with ethyl acetate. After purification over silica gel, there is obtained 4-[2,6-dichloro-4-(3,3-dichloroallyloxy)-benzyloxymethyl]-2,2-dimethyl-[1,3]dioxolane of formula

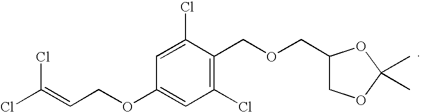

¹H NMR (300 MHz) CDCl₃: 6.85 (s, 2H), 6.1 (t, 1H), 4.75 (d, 2H), 4.6 (d, 2H), 4.25 (q, 1H), 4.1 (dd, 1H), 3.75 (dd, 1H), 3.65 (dd, 1H), 3.5 (dd, 1H), 1.4 (s, 3H), 1.35 (s, 3H).

3) At room temperature and under a nitrogen atmosphere, 2.04 g of 4-[2,6-dichloro-4-(3,3-dichloroallyloxy)-benzyloxymethyl]-2,2-dimethyl-[1,3]dioxolane are dissolved in 25 ml of toluene. 0.95 ml of 4-(trifluoromethoxy)-benzaldehyde and 93.2 mg of p-toluenesulfonic acid are added thereto. After stirring at 80° for 5 hours to complete the reaction, the mixture is cooled and poured into saturated sodium hydrogen carbonate solution. The crude product is extracted with ethyl acetate. As a result of purification over silica gel, two isomeric forms of the title compound (compound 2.3) are obtained.

### Example P3

### Preparation of (3-chlorophenoxy)-acetic acid 2,6-dichloro-4-(3,3-dichloroallyloxy)-benzyl ester of formula

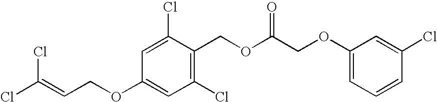

At 0° C., 35 mg of 3-chlorophenoxy acetic acid, 50 mg of [2,6-dichloro-4-(3,3-di-chloroallyloxy)-phenyl]-methanol and 22 mg of 4-(dimethylamino)-pyridine are initially dissolved in 3 ml of dichloromethane. 35 mg of N-(3-dimethylaminopropyl)-N′-ethyl-carbodiimide hydrochloride are added thereto. After 2 hours at 0° C. and 18 hours at room temperature, the reaction mixture is filtered over silica gel and concentrated. After purification over silica gel, the title compound (compound 3.5) is obtained.

### Example P4

### Preparation of 1,3-dichloro-5-(3,3-dichloroallyloxy)-2-[2-(3-ethynyloxy-phenoxy)-ethoxymethyl]-benzene of formula

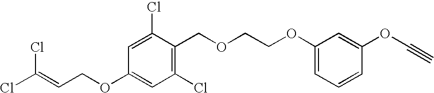

1) At 10° C., 5 g of [2,6-dichloro-4-(3,3-dichloroallyloxy)-phenyl]-methanol, 4.9 ml of bromoacetic acid tert-butyl ester and 1.4 g of tetrabutylammonium sulfate are introduced into 75 ml of benzene. 25 ml of 50% sodium hydroxide solution are added thereto. After 4 hours at 10° C., the organic phase is separated off, washed with dilute hydrochloric acid, dried and concentrated. After purification over silica gel, there is obtained [2,6-dichloro-4-(3,3-dichloroallyloxy)-benzyloxy]-acetic acid tert-butyl ester of formula

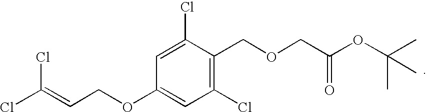

¹H NMR (300 MHz) CDCl₃: 6.9 (s, 2H), 6.1 (t, 1H), 4.9 (s, 2H), 4.6 (d, 2H), 4.0 (s, 2H), 1.5 (s, 9H).

2) At −78° C., 75 mg of lithium aluminium hydride are suspended in 3 ml of diethyl ether. A solution of 500 mg of [2,6-dichloro-4-(3,3-dichloroallyloxy)-benzyl]-acetic acid tert-butyl ester in 3 ml of diethyl ether is added dropwise thereto. After one hour at −78° C., there is added, dropwise, ethyl acetate and then, at 0° C., water. After filtration over silica gel, concentration is carried out. After purification over silica gel, there is obtained 2-[2,6-dichloro-4-(3,3-dichloroallyloxy)-benzyloxy]-ethanol of formula

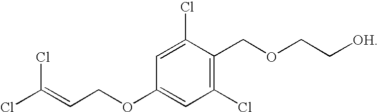

¹H NMR (300 MHz) CDCl₃: 6.9 (s, 2H), 6.1 (t, 1H), 4.8 (s, 2H), 4.6 (d, 2H), 3.7 (d, 2H), 3.6 (d, 2H).

3) At 0° C., 36 μl of azodicarboxylic acid diisopropyl ester are added to 157 mg of triphenylphospine in 1 ml of toluene. After 40 minutes, a solution of 50 mg of 2-[2,6-dichloro-4-(3,3-dichloroallyloxy)-benzyloxy]-ethanol and 25 mg of 3-ethynyloxy-phenol in 3 ml of toluene/tetrahydrofuran 4:1 is added dropwise. After 45 minutes at 0° C. and 18 hours at room temperature, the reaction mixture is concentrated. After purification over silica gel, the title compound (compound 4.4) is obtained.

### Example P5

### Preparation of 1,3-dichloro-5-(3,3-dichloroallyloxy)-2-(3-nitrobenzyloxymethyl)-benzene of formula

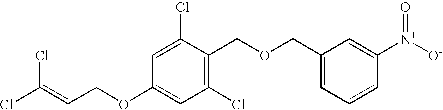

1) 18 mg of sodium hydride are suspended in 1 ml of tetrahydrofuran at 0° C. 0.63 mg of 3-nitrobenzyl alcohol are added thereto. After stirring for 30 minutes at room temperature to complete the reaction, a solution of 100 mg of 2,6-dichloro-4-(3,3-dichloroallyloxy)-benzyl-bromide in 1 ml of tetrahydrofuran is added dropwise, After 2 hours at 50° C., cooling to room temperature is carried out and 10 ml of brine are added cautiously. The crude product is extracted with ethyl acetate. After purification over silica gel, the title compound (compound 5.9) is obtained.

### Example P6

### Preparation of 1-[2,6-dichloro-4-(3,3-dichloroallyloxy)-benzyl]-3-(2-trifluoromethylphenyl)-urea of formula

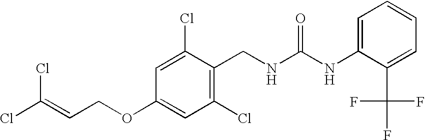

1) At 0° C., 192 μl of azodicarboxylic acid diisopropyl ester are added to 268 mg of triphenylphospine in 3 ml of tetrahydrofuran. After 20 minutes, a solution of 250 mg of 2-[2,6-dichloro-4-(3,3-dichloroallyloxy)-benzyloxy]-ethanol and 146 mg of phthalimide, dissolved in 5 ml of toluene, is added dropwise. After 45 minutes at 0° C. and 24 hours at room temperature, the reaction mixture is concentrated. After purification over silica gel, there is obtained 2-[2,6-dichloro-4-(3,3-dichloroallyloxy)-benzyl]-isoindole-1,3-dione of formula

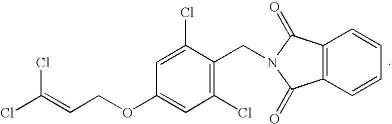

¹H NMR (300 MHz) CDCl₃: 7.7 (m, 2H), 7.6 (m, 2H), 6.9 (s, 2H), 6.1 (t, 1H), 5.0 (s, 2H), 4.6 (d, 2H).

2) 100 mg of 2-[2,6-dichloro-4-(3,3-dichloroallyloxy)-benzyl]-isoindole-1,3-dione are dissolved in 10 ml of tetrahydrofuran. At 65° C., 210 μl of hydrazine monohydrate, dissolved in 5 ml of ethanol, are added. After 72 hours at 65° C., the reaction mixture is cooled, filtered and concentrated. The crude product is taken up in dichloromethane and washed with sodium hydrogen carbonate solution and water. The solution is dried and concentrated. After purification over silica gel, there is obtained 6-dichloro-4-(3,3-dichloroallyloxy)-benzylamine of formula

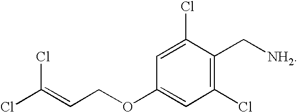

¹H NMR (300 MHz) CDCl₃: 6.8 (s, 2H), 6.05 (t, 1H), 4.55 (d, 2H), 3.95 (s, 2H), 1.9-1.6 (s, 2H).

3) At room temperature, 47 mg of 2-trifluoromethylphenyl isocyanate are introduced into 1 ml of tetrahydrofuran. 25 μl of triethylamine and 50 mg of 2,6-dichloro-4-(3,3-dichloroallyloxy)-benzylamine, dissolved in 2 ml of tetrahydrofuran, are added dropwise to the resulting solution. After 2 hours at room temperature, 84 mg of potassium sarcosinate and 10 ml of water are added. As a result of extraction with ethyl acetate, the crude product is isolated. After purification over silica gel, the title compound (compound 6.23) is obtained.

### Example P7

### Preparation of [2,6-dichloro-4-(3,3-dichloroallyloxy)-benzyl]-carbamic acid 4-nitrophenyl ester of formula

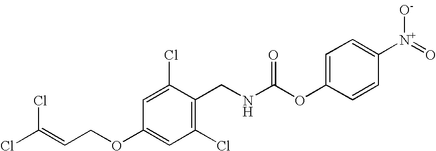

At 0° C., 50 mg of chloroformic acid 4-nitrophenyl ester are introduced into 1 ml of tetrahydrofuran. 35 μl of triethylamine and 50 mg of 2,6-dichloro-4-(3,3-dichloroallyloxy)-benzylamine, dissolved in 2 ml of tetrahydrofuran, are added dropwise to the resulting solution. After 2 hours, the mixture is warmed to room temperature. 84 mg of potassium sarcosinate and 10 ml of water are added. As a result of extraction with ethyl acetate, the crude product is isolated. After purification over silica gel, the title compound (compound 6.5) is obtained.

### Example P8

### Preparation of [2,6-dichloro-4-(3,3-dichloroallyloxy)-benzyloxy]-acetic acid 4-trifluoromethylphenyl ester of formula

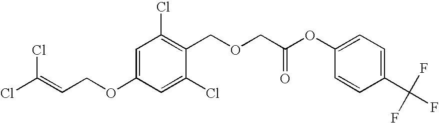

1) 500 mg of [2,6-dichloro-4-(3,3-dichloroallyloxy)-benzyloxy]-acetic acid tert-butyl ester are dissolved in 2.5 ml of dichloromethane. 1.19 ml of trifluoroacetic acid and 477 μl of triethylsilane are added thereto. After 45 minutes at room temperature, the reaction mixture is concentrated. After purification over silica gel, there is obtained 2,6-dichloro-4-(3,3-dichloroallyloxy)-benzyloxy]-acetic acid of formula

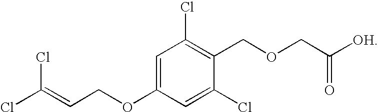

¹H NMR (300 MHz) CDCl₃: 6.7 (s,2H), 5.9 (t,1H), 4.7 (s,2H), 4.4 (d,2H), 4.0 (s,2H).

2) At 0° C., 95 mg of 2,6-dichloro-4-(3,3-dichloroallyloxy)-benzyloxy]-acetic acid, 47 mg of 4-trifluoromethylphenol and 36 mg of 4-(dimethylamino)-pyridine are initially dissolved in 3 ml of dichloromethane. 56 mg of N-(3-dimethylaminopropyl)-N′-ethylcarbodiimide hydrochloride are added thereto. After 2 hours at 0° C. and 18 hours at room temperature, the reaction mixture is filtered over silica gel and concentrated. After purification over silica gel, the title compound (compound 7.2) is obtained.

### Example P9

### Preparation of [2-[2,6-dichloro-4-(3,3-dichloroallyloxy)-benzyloxy]-N-(3-trifluoromethoxyphenyl)-acetamide of formula

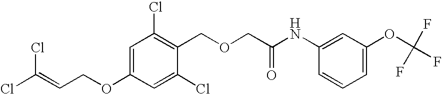

At room temperature, 50 mg of 2,6-dichloro-4-(3,3-dichloroallyloxy)-benzyloxy]-acetic acid are initially dissolved in 1 ml of dimethylformamide. 30 mg of 3-trifluoromethoxyaniline, 35 μl of N-ethyldiisopropylamine and 42 mg of bis(2-oxo-3-oxazolidinyl)phosphinic acid chloride are added thereto. After 20 hours at room temperature, the reaction mixture is poured into water and extracted with dichloromethane. After purification over silica gel, the title compound (compound 7.4) is obtained.

### Example P10

### Preparation of [4-trifluoromethyl-benzoic acid 2-[2,6-dichloro-4-(3,3-dichloroallyloxy)-benzyloxy]-ethyl ester of formula

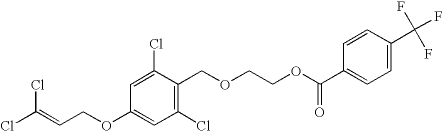

At 0° C., 50 mg of 2-[2,6-dichloro-4-(3,3-dichloroallyloxy)-benzyloxy]-ethanol, 30 mg of 4-trifluoromethylbenzoic acid and 19 mg of 4-(dimethylamino)-pyridine are initially dissolved in 3 ml of dichloromethane. 30 mg of N-(3-dimethylaminopropyl)-N′-ethylcarbodiimide hydrochloride are added thereto. After 2 hours at 0° C. and 18 hours at room temperature, the reaction mixture is filtered over silica gel and concentrated. After purification over silica gel, the title compound (compound 8.11) is obtained.

### Example P11

In analogous manner to that described hereinabove, the further compounds of the following Tables 1 to 8 can also be prepared. In the Tables, the bond indicated by ---- denotes the connection of the indicated structural moiety to the basic structure; m.p. denotes the melting point in ° C.

TABLE 1
Compounds of formula

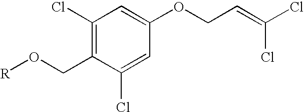

| No. | R | ¹H NMR(CDCl₃)300 MHz | Phys. data |
|---|---|---|---|
| 1.1 | 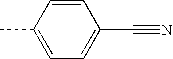 | | oil |
| 1.2 | 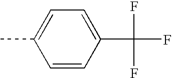 | 7.7(d, 2H), 7.25(d, 2H), 7.1(s, 2H), 6.35(t, 1H), 5.45(s, 2H), 4.85(d, 2H) | oil |
| 1.3 | 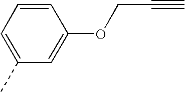 | 7.1(m, 1H), 6.8(s, 2H)6.5(m, 3H), 6.0(t, 1H), 5.05(s, 2H), 4.55(m, 4H), 2.4(m, 1H). | oil |
| 1.4 | 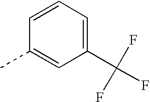 | 7.35(t, 1H), 7.2(m, 3H), 6.85(s, 2H)6.05(t, 1H), 5.15(s, 2H), 4.6(d, 2H). | oil |
| 1.5 | 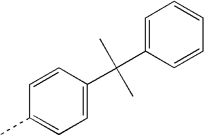 | | oil |
| 1.6 | 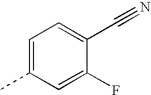 | | oil |
| 1.7 | 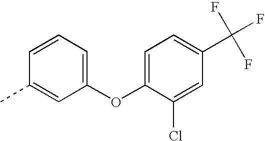 | | oil |
| 1.8 | 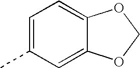 | 6.75(s, 2H), 6.55(d, 1H), 6.45(s, 1H), 6.3(d, 1H), 5.95(t, 1H), 5.75(s, 2H), 4.95(s, 2H), 4.5(d, 2H). | oil |
| 1.9 | 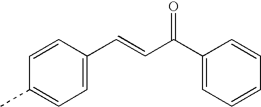 | 8.05-7.4(m, 9H), 7.05(d, 2H), 6.95(s, 2H), 6.15(t, 1H), 5.75(s, 2H), 4.65(d, 2H). | oil |
| 1.10 | 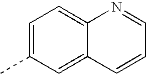 | | oil |
| 1.11 | 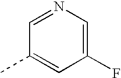 | | oil |
| 1.12 | 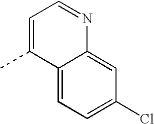 | 8.75(s, 1H), 8.0(d, 1H), 7.95(s, 1H), 7.3(d, 2H)6.9(s, 2H), 6.85(m, 1H), 6.05(t, 1H), 5.35(s, 2H), 4.6(d, 2H). | oil |
| 1.13 | 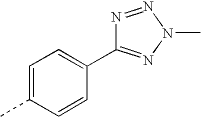 | | oil |
| 1.14 | 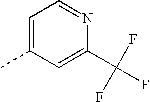 | 8.8(d, 1H), 7.55(m, 1H), 7.3(m, 1H), 7.15(s, 2H), 6.35(t, 1H), 5.55(s, 2H), 4.85(d, 2H) | oil |
| 1.15 | 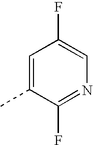 | | oil |
| 1.16 | 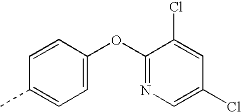 | | oil |
| 1.17 | 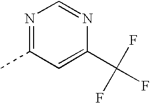 | 8.8(s, 1H), 6.9(s, 1H), 6.8(s, 2H), 6.0(t, 1H), 5.55(s, 2H), 4.5(d, 2H) | oil |
| 1.18 | 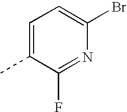 | | oil |
| 1.19 | 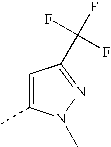 | | oil |
| 1.20 | 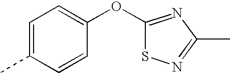 | | oil |
| 1.21 | 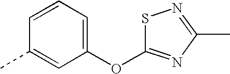 | 7.25-6.75(m, 4H), 6.7(s, 2H), 5.95(t, 1H), 5.05(s, 2H), 4.45(d, 2H), 2.35(s, 3H). | oil |
| 1.22 | 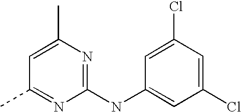 | | oil |
| 1.23 | 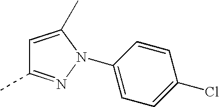 | 7.35(s, 4H), 6.85(s, 2H), 6.05(t, 1H), 5.65(s, 1H), 5.45(s, 2H), 4.55(d, 2H), 2.25(s, 3H). | oil |
| 1.24 | 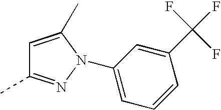 | | oil |
| 1.25 | 2-chloro-phenyl | | |
| 1.26 | 3-chloro-phenyl | | |
| 1.27 | 4-chloro-phenyl | | |
| 1.28 | 3,4-dichloro-phenyl | | |
| 1.29 | 3,5-dichloro-phenyl | | |
| 1.30 | 2,4-dichloro-phenyl | | |
| 1.31 | 2-bromo-phenyl | | |
| 1.32 | 3-bromo-phenyl | | |
| 1.33 | 4-bromo-phenyl | | |
| 1.34 | 3,5-dibromo-phenyl | | |
| 1.35 | 2,4-dibromo-phenyl | | |
| 1.36 | 2-fluoro-phenyl | | |
| 1.37 | 3-fluoro-phenyl | | |
| 1.38 | 4-fluoro-phenyl | | |
| 1.39 | 3,5-difluoro-phenyl | | |
| 1.40 | 2,4-difluoro-phenyl | | |
| 1.41 | 2-nitro-phenyl | | |
| 1.42 | 3-nitro-phenyl | | |
| 1.43 | 4-nitro-phenyl | | |
| 1.44 | 2-cyano-phenyl | | |
| 1.45 | 3-cyano-phenyl | | |
| 1.46 | 3,5-ditrifluoromethyl-phenyl | | |
| 1.47 | 3-trifluoromethyl-phenyl | | |
| 1.48 | 4-trifluoromethyl-phenyl | | |
| 1.49 | 2-methyl-phenyl | | |
| 1.50 | 3-methyl-phenyl | | |
| 1.51 | 4-methyl-phenyl | | |
| 1.52 | 3,5-dimethyl-phenyl | | |
| 1.53 | 3-methoxy-phenyl | | |
| 1.54 | 4-methoxy-phenyl | | |
| 1.55 | 3,5-dimethoxy-phenyl | | |
| 1.56 | 4-acetyl-phenyl | | |
| 1.57 | 4-acetyl-2-fluoro-phenyl | | |
| 1.58 | 3-trifluoromethyl-2-pyridyl | | |
| 1.59 | 2-chloro-5-pyridiyl | | |
| 1.60 | 2,6-dichloro-4-pyridyl | | |
| 1.61 | 3-trifluoromethyl-2-pyrimidyl | | |

TABLE 2
Compounds of formula

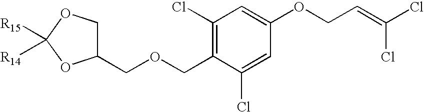

| No. | R₁₄ | R₁₅ | ¹H NMR(CDCl₃)300 MHz | | Phys. data |
|---|---|---|---|---|---|
| 2.1 | —CH₃ | —CH₃ | 6.85(s, 2H), 6.1(t, | | oil |
| | | | 1H), 4.75(d, 2H), | | |
| | | | 4.6(d, 2H), 4.25(q, | | |
| | | | 1H), 4.1(dd, 1H), | | |
| | | | 3.75(dd, 1H), 3.65(dd, | | |
| | | | 1H), 3.5(dd, | | |
| | | | 1H), 1.4(s, 3H), | | |
| | | | 1.35(s, 3H). | | |
| 2.2 | —CH₂CF₃ | H | | | oil |
| 2.3 | 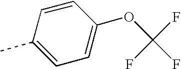 | H | isomer A 7.55(d, 2H), 7.25(d, 2H), 6.9(s, 2H), 6.15(t, 1H), 5.95(s, 1H), 4.8(s, 2H), 4.65(d, 2H), 4.45(q, 1H), 4.25(dd, 1H), 3.9(dd, 1H), 3.7(m, 2H). | isomer B: 7.55(d, 2H), 7.25(d, 2H), 6.9(s, 2H), 6.15(t, 1H), 5.8(s, 1H), 4.75(d, 2H), 4.65(d, 2H), | |
| #4.45(q, 1H), 4.15(m, 2H), 3.75(m, 1H), 3.6(m, 1H) | oil | | | | |
| 2.4 | 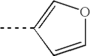 | H | 7.45(d, 1H), 7.3(s, 1H), 6.85(s, 2H), 6.05(t, 1H), 5.9(s, 1H), isomer A), 5.75(s, 1H), isomer B), 4.7(m, 2H), 4.55(d, 2H), 4.3(m, 1H), 4.15-3.45(m 4H). | | oil |
| 2.5 | 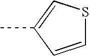 | H | | | oil |
| 2.6 | 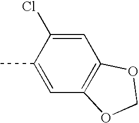 | H | isomer A 7.0(s, 1H), 6.75(s, 2H), 6.7(s, 1H), 6.0(m, 2H), 5.85(s, 2H), 4.65(m, 2H), 4.55(d, 2H), 4.3-3.45(m, 5H). | isomer B: 7.0(s, 1H), 6.85(s, 2H), 6.75(s, 1H), 6.05(m, 2H), 5.9(s, 2H), 4.75(m, 2H), 4.55(d, 2H), 4.4-3.5(m, 5H). | oil |
| 2.7 | 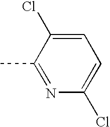 | H | 7.75(d, 1H), 7.3(d, 1H), 6.9(s, 2H), 6.4(s, 1H, isomer A), 6.3(s, 1H, isomer B), 6.15(t, 1H), 4.85-4.4(m, 5H), 4.45(m, 1H), isomer A), 4.4(m, 1H), isomer B), 4.2-3.6(m, 3H). | | oil |
| 2.8 | 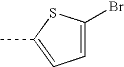 | H | isomer A: 6.85(m, 4H), 6.25(s, 1H), 6.05(t, 1H), 5.9(s, 1H), 4.7(m, 2H), 4.55(d, 2H), 4.3(m, 1H), 4.15-3.45(m, 4H). | isomer B: 7.05(m, 4H), 6.25(t, 1H), 6.1(s, 1H), 4.9(m, 2H), 4.75(d, 2H), 4.55(m, 1H), 4.35-3.7(m, 4H). | oil |
| 2.9 | 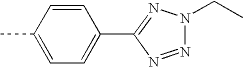 | H | | | oil |
| 2.10 | 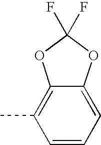 | H | isomer A: 7.15(m, 1H), 6.95(m, 2H), 6.85(s, 2H), 6.05(m, 2H), 4.75(s, 2H), 4.55(d, 2H), 4.4(q, 1H), 4.15(dd, 1H), 3.85(dd, 1H), 3.65(m, 2H). | isomer B: 7.15(m, 1H), 7.0(m, 2H), 6.8(s, 2H), 6.05(t, 1H), 5.9(s, 1H), 4.7(m, 2H), 4.55(d, 2H), 4.35(q, | |
| #1H), 4.0(m, 2H), 3.65(dd, 1H), 3.55(dd, 1H). | oil | | | | |
| 2.11 | 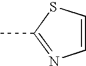 | H | isomer A: 7.85(d, 1H), 7.35(d, 1H), 6.9(s, 2H), 6.25(s, 1H), 6.15(t, 1H), 4.8(s, 2H), 4.65(d, 2H), 4.5(m, 1H), 4.25(dd, 1H), 4.0(dd, 1H), 3.7(m, 2H). | isomer B: 7.95(d, 1H), 7.5(d, 1H), 7.0(s, 2H), 6.25(m, 2H), 4.9(m, 2H), 4.75(d, 2H), 4.6(m, 1H), | |
| #4.25(m, 2H), 3.9(dd, 1H), 3.75(dd, 1H). | oil | | | | |
| 2.12 | 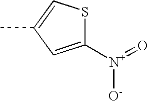 | H | isomer A 7.75(s, 1H), 7.4(s, 1H), 6.7(s, 2H), 5.9(t, 1H), 5.7(s, 1H), 4.6(s, 2H), 4.45(d, 2H), 4.2(q, 1H), 3.95(dd, 1H), 3.65(dd, 1H), 3.45(m, 2H). | isomer B 7.7(s, 1H), 7.35(s, 1H), 6.65(s, 2H), 5.9(t, 1H), 5.55(s, 1H), 4.5(s, 2H), 4.35(d, 2H), | |
| #4.15(m, 1H), 3.85(dd, 1H), 3.75(dd, 1H), 3.4(m, 2H). | oil | | | | |
| 2.13 | 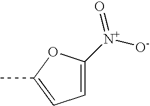 | H | | | oil |
| 2.14 | 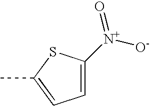 | H | isomer A: 7.65(d, 1H), 6.9(d, 1H), 6.75(s, 2H), 6.0(s, 1H), 5.95(t, 1H), 4.65(s, 2H), 4.45(d, 2H), 4.25(m, 1H), 4.0(dd, 1H), 3.75(dd, 1H), 3.5(m, 2H). | isomer B: 7.6(d, 1H), 6.95(d, 1H), 6.7(s, 2H), 5.95(t, 1H), 5.85(s, 1H), 4.6(s, 2H), 4.45(d, 2H), | |
| #4.25(m, 1H), 3.95(dd, 1H), 3.85(dd, 1H), 3.45(m, 2H). | oil | | | | |
| 2.15 | 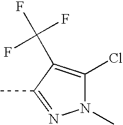 | H | 6.9(s, 2H), 6.15(m, 2H), 6.95(s, 1H), 4.8(m, 2H), 4.65(d, 2H), 4.55(m, 1H, isomer A), 4.4(m, 1H, isomer B), 4.2-3.6(m, 7H). | | oil |
| 2.16 | 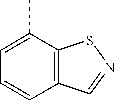 | H | | | oil |
| 2.17 | 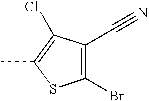 | H | isomer A: 7.0(s, 2H), 6.25(s, 1H), 6.2(t, 1H), 4.85(s, 2H), 4.75(d, 2H), 4.5(m, 1H), 4.3(dd, 1H), 4.05(dd, 1H), 3.75(m, 2H). | isomer B: 6.95(s, 2H), 6.2(t, 1H), 6.15(s, 1H), 4.8(s, 2H), 4.7(d, 2H), 4.45(m, 1H), 4.1(m, 2H), 3.7(m, 2H). | oil |
| 2.18 | 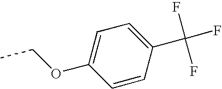 | H | | | oil |
| 2.19 | 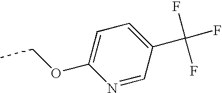 | H | | | oil |
| 2.20 | 2-chloro-phenyl | H | | | |
| 2.21 | 3-chloro-phenyl | H | | | |
| 2.22 | 4-chloro-phenyl | H | | | |
| 2.23 | 3,4-dichloro-phenyl | H | | | |
| 2.24 | 3,5-dichloro-phenyl | H | | | |
| 2.25 | 2,4-dichloro-phenyl | H | | | |
| 2.26 | 2-bromo-phenyl | H | | | |
| 2.27 | 3-bromo-phenyl | H | | | |
| 2.28 | 4-bromo-phenyl | H | | | |
| 2.29 | 3,5-dibromo-phenyl | H | | | |
| 2.30 | 2,4-dibromo-phenyl | H | | | |
| 2.31 | 2-fluoro-phenyl | H | | | |
| 2.32 | 3-fluoro-phenyl | H | | | |
| 2.33 | 4-fluoro-phenyl | H | | | |
| 2.34 | 3,5-difluoro-phenyl | H | | | |
| 2.35 | 2,4-difluoro-phenyl | H | | | |
| 2.36 | 2-nitro-phenyl | H | | | |
| 2.37 | 3-nitro-phenyl | H | | | |
| 2.38 | 4-nitro-phenyl | H | | | |
| 2.39 | 2-cyano-phenyl | H | | | |
| 2.40 | 3-cyano-phenyl | H | | | |
| 2.41 | 4-cyano-phenyl | H | | | |
| 2.42 | 3,5-ditrifluoromethyl-phenyl | H | | | |
| 2.43 | 3-trifluoromethyl-phenyl | H | | | |
| 2.44 | 4-trifluoromethyl-phenyl | H | | | |
| 2.45 | 2-methyl-phenyl | H | | | |
| 2.46 | 3-methyl-phenyl | H | | | |
| 2.47 | 4-methyl-phenyl | H | | | |
| 2.48 | 3,5-dimethyl-phenyl | H | | | |
| 2.49 | 3-methoxy-phenyl | H | | | |
| 2.50 | 4-methoxy-phenyl | | | | |
| 2.51 | 3,5-dimethoxy-phenyl | H | | | |
| 2.52 | 4-acetyl-phenyl | H | | | |
| 2.53 | 4-acetyl-2-fluoro-phenyl | H | | | |
| 2.54 | 3-trifluoromethyl-2-pyridyl | H | | | |
| 2.55 | 2-chloro-5-pyridyl | H | | | |
| 2.56 | 2,6-dichloro-4-pyridyl | H | | | |
| 2.57 | 3-trifluoromethyl-2-pyrimidyl | H | | | |

TABLE 3
Compounds of formula

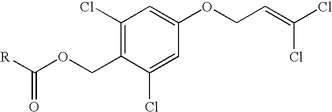

| No. | R | ¹H NMR(CDCl₃)300 MHz | Phys. data |
|---|---|---|---|
| 3.1 | 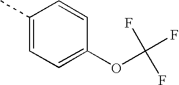 | | oil |
| 3.2 | 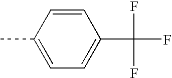 | 8.1(d, 2H), 7.6(d, 2H), 6.85(s, 2H), 6.05(t, 1H), 5.55(s, 2H), 4.6(d, 2H) | oil |
| 3.3 | 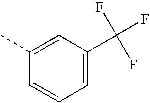 | | oil |
| 3.4 | 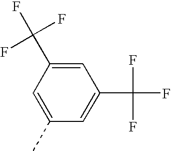 | | oil |
| 3.5 | 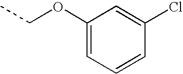 | 7.25(t, 1H), 7.0(d, 1H), 6.95(s, 3H), 6.85(d, 1H), 6.15(t, 1H), 5.5(s, 2H), 4.7(m, 4H) | oil |
| 3.6 | 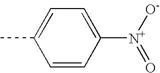 | | oil |
| 3.7 | 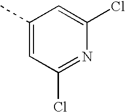 | | oil |
| 3.8 | 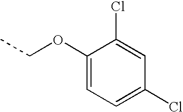 | | oil |
| 3.9 | 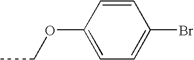 | | oil |
| 3.10 | 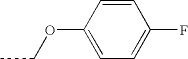 | | oil |
| 3.11 | 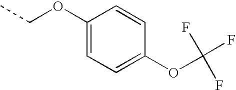 | | oil |
| 3.12 | 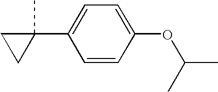 | 7.3-6.8(m, 6H), 6.25(t, 1H), 5.3(s, 2H), 4.65(d, 2H), 4.55(q, 1H), 1.6(m, 2H), 1.35(d, 6H), 1.15(m, 2H). | oil |
| 3.13 | 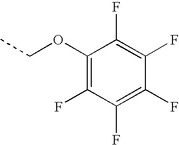 | 6.9(s, 2H), 6.1(t, 1H), 5.45(s, 2H), 4.85(s, 2H), 4.65(d, 2H) | oil |
| 3.14 | 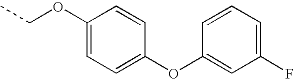 | | oil |
| 3.15 | 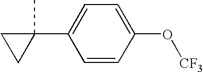 | 7.3(d, 2H), 7.05(d, 2H), 6.8(s, 2H), 6.05(t, 1H), 5.2(s, 2H), 4.55(d, 2H), 1.6(m, 2H), 1.1(m, 2H). | oil |
| 3.16 | 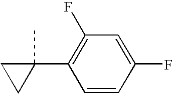 | | m.p.: 63-64° C. |
| 3.17 | 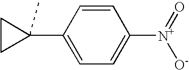 | | m.p.: 107-108° C. |
| 3.18 | 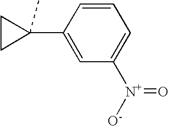 | | oil |
| 3.19 | 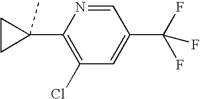 | 8.9(s, 1H), 8.15(s, 1H), 7.1(s, 2H), 6.35(t, 1H), 5.6(s, 2H), 4.85(d, 2H), 2.05(m, 2H), 1.7(m, 2H). | oil |
| 3.20 | CH₃ | | |
| 3.21 | C₂H₅ | | |
| 3.22 | n-C₃H₇ | | |
| 3.23 | n-C₄H₉ | | |
| 3.24 | n-C₅H₁₁ | | |
| 3.25 | iso-C₃H₇ | | |
| 3.26 | 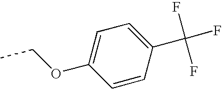 | | |
| 3.27 | 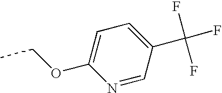 | | |
| 3.28 | 2-chloro-phenyl | | |
| 3.29 | 3-chloro-phenyl | | |
| 3.30 | 4-chloro-phenyl | | |
| 3.31 | 3,4-dichloro-phenyl | | |
| 3.32 | 3,5-dichloro-phenyl | | |
| 3.33 | 2,4-dichloro-phenyl | | |
| 3.34 | 2-bromo-phenyl | | |
| 3.35 | 3-bromo-phenyl | | |
| 3.36 | 4-bromo-phenyl | | |
| 3.37 | 3,5-dibromo-phenyl | | |
| 3.38 | 2,4-dibromo-phenyl | | |
| 3.39 | 2-fluoro-phenyl | | |
| 3.40 | 3-fluoro-phenyl | | |
| 3.41 | 4-fluoro-phenyl | | |
| 3.42 | 3,5-difluoro-phenyl | | |
| 3.43 | 2,4-difluoro-phenyl | | |
| 3.44 | 2-nitro-phenyl | | |
| 3.45 | 3-nitro-phenyl | | |
| 3.46 | 2-cyano-phenyl | | |
| 3.47 | 3-cyano-phenyl | | |
| 3.48 | 4-cyano-phenyl | | |
| 3.49 | 3,5-ditrifluoromethyl-phenyl | | |
| 3.50 | 2-methyl-phenyl | | |
| 3.51 | 3-methyl-phenyl | | |
| 3.52 | 4-methyl-phenyl | | |
| 3.53 | 3,5-dimethyl-phenyl | | |
| 3.54 | 3-methoxy-phenyl | | |
| 3.55 | 4-methoxy-phenyl | | |
| 3.56 | 3,5-dimethoxy-phenyl | | |
| 3.57 | 4-acetyl-phenyl | | |
| 3.58 | 4-acetyl-2-fluoro-phenyl | | |
| 3.59 | 3-trifluoromethyl-2-pyridyl | | |
| 3.60 | 2-chloro-5-pyridyl | | |
| 3.61 | 2,6-dichloro-4-pyridyl | | |
| 3.62 | 3-trifluoromethyl-2-pyrimidyl | | |

TABLE 4
Compounds of formula

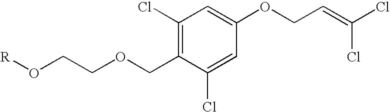

| No. | R | ¹H NMR(CDCl₃)300 MHz | Phys. data |
|---|---|---|---|
| 4.1 | H | | oil |
| 4.2 | 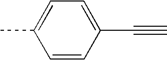 | 7.55(d, 2H), 6.95(d, 2H), 6.9(s, 2H), 6.15(t, 1H), 4.8(s, 2H), 4.65(d, 2H), 4.2(t, 2H), 3.9(t, 2H). | oil |
| 4.3 | 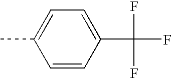 | | oil |
| 4.4 | 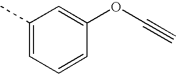 | 7.2(t, 1H), 6.9(s, 2H), 6.55(m, 3H), 6.15(t, 1H), 5.95(s, 1H), 4.8(s, 2H), 4.65(s, 2H), 4.6(d, 2H), 4.15(t, 2H), 3.9(t, 2H), 2.55(s, 1H). | oil |
| 4.5 | 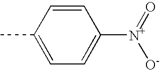 | | oil |
| 4.6 | 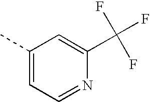 | | oil |
| 4.7 | 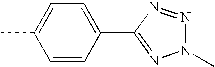 | 7.85(d, 2H), 6.85(d, 2H), 6.75(s, 2H), 5.95(t, 1H), 4.7(s, 2H), 4.45(d, 2H), 4.05(t, 2H), 3.75(t, 2H). | oil |
| 4.8 | 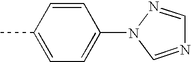 | | oil |
| 4.9 | 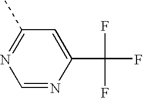 | | oil |
| 4.10 | 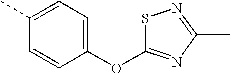 | | m.p. 95-97 |
| 4.11 | 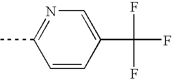 | 8.45(s, 1H), 7.75(d, 1H), 6.9(s, 2H), 6.85(d, 1H), 6.15(t, 1H), 4.85(s, 2H), 4.65(d, 2H), 4.6(t, 2H), 3.9(t, 2H). | |
| 4.12 | CH₃ | | |
| 4.13 | C₂H₅ | | |
| 4.14 | n-C₃H₇ | | |
| 4.15 | n-C₄H₉ | | |
| 4.16 | n-C₅H₁₁ | | |
| 4.17 | iso-C₃H₇ | | |
| 4.18 | 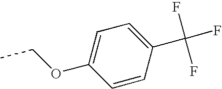 | | |
| 4.19 | 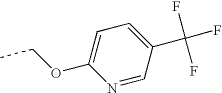 | | |
| 4.20 | 2-chloro-phenyl | | |
| 4.21 | 3-chloro-phenyl | | |
| 4.22 | 4-chloro-phenyl | | |
| 4.23 | 3,4-dichloro-phenyl | | |
| 4.24 | 3,5-dichloro-phenyl | | |
| 4.25 | 2,4-dichloro-phenyl | | |
| 4.26 | 2-bromo-phenyl | | |
| 4.27 | 3-bromo-phenyl | | |
| 4.28 | 4-bromo-phenyl | | |
| 4.29 | 3,5-dibromo-phenyl | | |
| 4.30 | 2,4-dibromo-phenyl | | |
| 4.31 | 2-fluoro-phenyl | | |
| 4.32 | 3-fluoro-phenyl | | |
| 4.33 | 4-fluoro-phenyl | | |
| 4.34 | 3,5-difluoro-phenyl | | |
| 4.35 | 2,4-difluoro-phenyl | | |
| 4.36 | 2-nitro-phenyl | | |
| 4.37 | 3-nitro-phenyl | | |
| 4.38 | 2-cyano-phenyl | | |
| 4.39 | 3-cyano-phenyl | | |
| 4.40 | 4-cyano-phenyl | | |
| 4.41 | 3,5-ditrifluoromethyl-phenyl | | |
| 4.42 | 3-trifluoromethyl-phenyl | | |
| 4.43 | 2-methyl-phenyl | | |
| 4.44 | 3-methyl-phenyl | | |
| 4.45 | 4-methyl-phenyl | | |
| 4.46 | 3,5-dimethyl-phenyl | | |
| 4.47 | 3-methoxy-phenyl | | |
| 4.48 | 4-methoxy-phenyl | | |
| 4.49 | 3,5-dimethoxy-phenyl | | |
| 4.50 | 4-acetyl-phenyl | | |
| 4.51 | 4-acetyl-2-fluoro-phenyl | | |
| 4.52 | 3-trifluoromethyl-2-pyridyl | | |
| 4.53 | 2-chloro-5-pyridyl | | |
| 4.54 | 2,6-dichloro-4-pyridyl | | |

TABLE 5
Compounds of formula

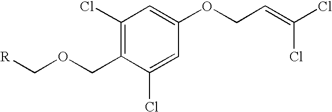

| No. | R | ¹H NMR(CDCl₃)300 MHz | Phys. data |
|---|---|---|---|
| 5.1 | 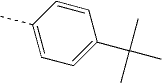 | | oil |
| 5.2 | 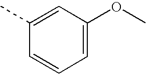 | | oil |
| 5.3 | 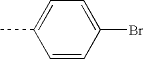 | 7.5(d, 2H), 7.3(d, 2H), 6.9(s, 2H), 6.15(t, 1H), 4.75(s, 2H), 4.65(d, 2H), 4.6(s, 2H). | oil |
| 5.4 | 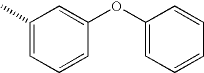 | | oil |
| 5.5 | 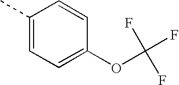 | 7.3(d, 2H), 7.05(d, 2H), 6.75(s, 2H), 6.0(t, 1H), 4.65(s, 2H), 4.5(d, 2H), 4.45(s, 2H). | oil |
| 5.6 | 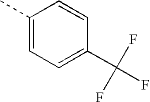 | 7.3(d, 2H), 7.05(d, 2H), 6.75(s, 2H), 6.0(t, 1H), 4.65(s, 2H), 4.85(s, 2H), 4.8(d, 2H). | oil |
| 5.7 | 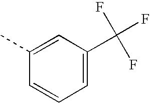 | | oil |
| 5.8 | 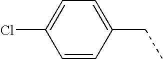 | 7.3-7.1(m, 4H), 6.85(s, 2H), 6.15(t, 1H), 4.75(s, 2H), 4.65(d, 2H), 3.75(t, 2H), 2.85(t, 2H). | oil |
| 5.9 | 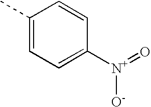 | 7.8(d, 2H), 7.7(d, 2H), 7.1(s, 2H), 6.3(t, 1H), 4.95(s, 2H), 4.5(d, 2H), 4.45(s, 2H). | oil |
| 5.10 | 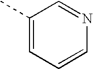 | | oil |
| 5.11 | 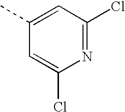 | 7.25(s, 2H), 6.9(s, 2H), 6.15(t, 1H), 4.7(s, 2H), 4.65(d, 2H), 4.55(s, 2H). | oil |
| 5.12 | 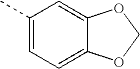 | | oil |
| 5.13 | 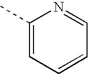 | | oil |
| 5.14 | 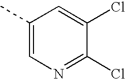 | 8.25(s, 1H), 7.85(s, 1H), 6.9(s, 2H), 6.15(t, 1H), 4.8(s, 2H), 4.65(d, 2H), 4.6(s, 2H). | oil |
| 5.15 | 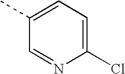 | | oil |
| 5.16 | 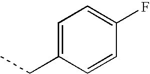 | 7.2-6.9(m, 4H), 6.85(s, 2H), 6.15(t, 1H), 4.7(s, 2H), 4.65(d, 2H), 3.75(t, 2H), 2.9(t, 2H) | oil |
| 5.17 | 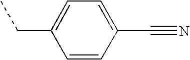 | | oil |
| 5.18 | 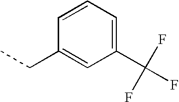 | 7.5-7.3(m, 4H), 6.85(s, 2H), 6.1(t, 1H), 4.7(s, 2H), 4.65(d, 2H), 3.75(t, 2H), 2.95(t, 2H). | oil |
| 5.19 | 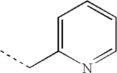 | | oil |
| 5.20 | 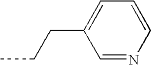 | | oil |
| 5.21 | 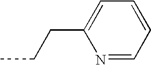 | | oil |
| 5.22 | 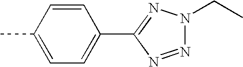 | | oil |
| 5.23 | 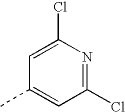 | | oil |
| 5.24 | 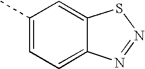 | | oil |
| 5.25 | 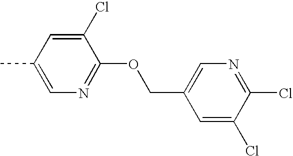 | | oil |
| 5.26 | 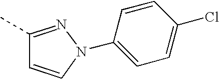 | | oil |
| 5.27 | 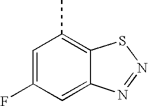 | | 95-97 |
| 5.28 | 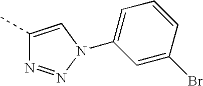 | | 82-85 |
| 5.29 | 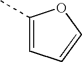 | | oil |
| 5.30 | 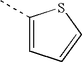 | 7.05(d, 1H), 6.85(m, 1H), 6.75(m, 1H), 6.65(s, 2H), 5.9(t, 1H), 4.5(d, 4H), 4.4(d, 2H). | oil |
| 5.31 | 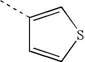 | | oil |
| 5.32 | 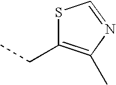 | 8.5(s, 1H), 6.75(s, 2H), 6.0(t, 1H), 4.6(s, 2H), 4.5(d, 2H), 3.6(t, 2H), 2.95(t, 2H), 2.3(s, 3H). | oil |
| 5.33 | 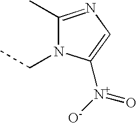 | | oil |
| 5.34 | 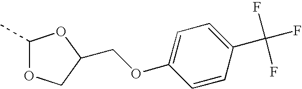 | | oil |
| 5.35 | 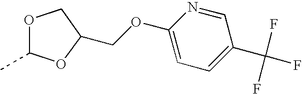 | | oil |
| 5.36 | H | | |
| 5.37 | CH₃ | | |
| 5.38 | C₂H₅ | | |
| 5.39 | n-C₃H₇ | | |
| 5.40 | n-C₄H₉ | | |
| 5.41 | n-C₅H₁₁ | | |
| 5.42 | iso-C₃H₇ | | |
| 5.43 | 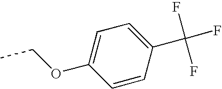 | | |
| 5.44 | 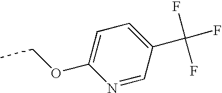 | | |
| 5.45 | 2-chloro-phenyl | | |
| 5.46 | 3-chloro-phenyl | | |
| 5.47 | 4-chloro-phenyl | | |
| 5.48 | 3,4-dichloro-phenyl | | |
| 5.49 | 3,5-dichloro-phenyl | | |
| 5.50 | 2,4-dichloro-phenyl | | |
| 5.51 | 2-bromo-phenyl | | |
| 5.52 | 3-bromo-phenyl | | |
| 5.53 | 4-bromo-phenyl | | |
| 5.54 | 3,5-dibromo-phenyl | | |
| 5.55 | 2,4-dibromo-phenyl | | |
| 5.56 | 2-fluoro-phenyl | | |
| 5.57 | 3-fluoro-phenyl | | |
| 5.58 | 4-fluoro-phenyl | | |
| 5.59 | 3,5-difluoro-phenyl | | |
| 5.60 | 2,4-difluoro-phenyl | | |
| 5.61 | 2-nitro-phenyl | | |
| 5.62 | 3-nitro-phenyl | | |
| 5.63 | 4-nitro-phenyl | | |
| 5.64 | 2-cyano-phenyl | | |
| 5.65 | 3-cyano-phenyl | | |
| 5.66 | 4-cyano-phenyl | | |
| 5.67 | 3,5-ditrifluoromethyl-phenyl | | |
| 5.68 | 3-trifluoromethyl-phenyl | | |
| 5.69 | 4-trifluoromethyl-phenyl | | |
| 5.70 | 2-methyl-phenyl | | |
| 5.71 | 3-methyl-phenyl | | |
| 5.72 | 4-methyl-phenyl | | |
| 5.73 | 3,5-dimethyl-phenyl | | |
| 5.74 | 3-methoxy-phenyl | | |
| 5.75 | 4-methoxy-phenyl | | |
| 5.76 | 3,5-dimethoxy-phenyl | | |
| 5.77 | 4-acetyl-phenyl | | |
| 5.78 | 4-acetyl-2-fluoro-phenyl | | |
| 5.79 | 3-trifluoromethyl-2-pyridyl | | |
| 5.80 | 2-chloro-5-pyridyl | | |
| 5.81 | 2,6-dichloro-4-pyridyl | | |
| 5.82 | 3-trifluoromethyl-2-pyrimidyl | | |

and also the compounds of formulae

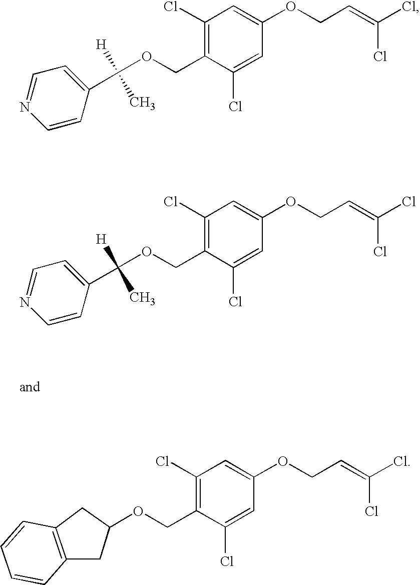

TABLE 6
Compounds of formula

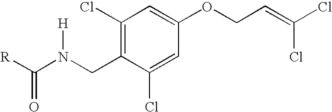

| No. | R | ¹H NMR(CDCl₃)300 MHz | m.p. ° C. |
|---|---|---|---|
| 6.1 | 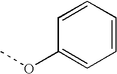 | | |
| 6.2 | 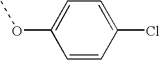 | | 121-123 |
| 6.3 | 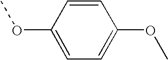 | | |
| 6.4 | 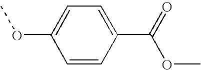 | | |
| 6.5 | 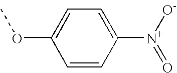 | 8.05(d, 2H), 7.15(d, 2H), 6.75(s, 2H), 5.95(t, 1H), 5.3(s, 1H), 4.55(d, 2H), 4.45(d, 2H). | |
| 6.6 | 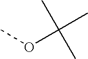 | | |
| 6.7 | 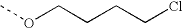 | | |
| 6.8 | 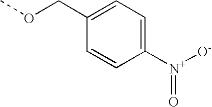 | 8.0(d, 2H), 7.4(d, 2H), 6.7(s, 2H), 5.95(t, 1H), 4.45(d, 2H), 3.85(s, 2H), 3.75(s, 2H). | |
| 6.9 | 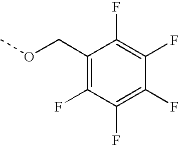 | | 99-102 |
| 6.10 | 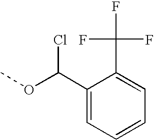 | | 118-127 |
| 6.11 | 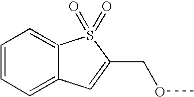 | | |
| 6.12 | 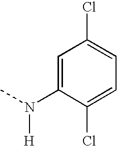 | | |
| 6.13 | 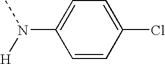 | | 230-232 |
| 6.14 | 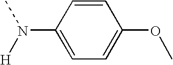 | | |
| 6.15 | 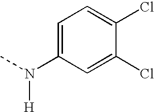 | 7.75(s, 1H), 7.6(d, 1H), 7.2(d, 1H), 6.85(s, 2H), 6.1(t, 1H), 4.45(s, 1H), 4.65(d, 4H). | |
| 6.16 | 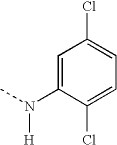 | | |
| 6.17 | 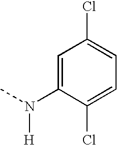 | | |
| 6.18 | 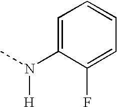 | | |
| 6.19 | 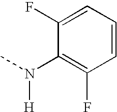 | | |
| 6.20 | 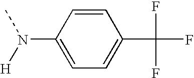 | | |
| 6.21 | 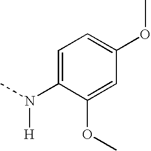 | | |
| 6.22 | 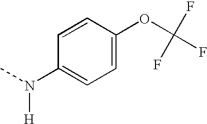 | | 166-167 |
| 6.23 | 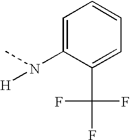 | | 215-216 |
| 6.24 | 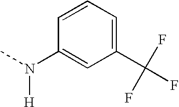 | | 104-108 |
| 6.25 | 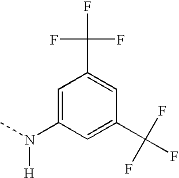 | | 184-186 |
| 6.26 | 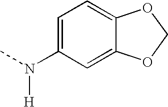 | | |

TABLE 7
Compounds of formula

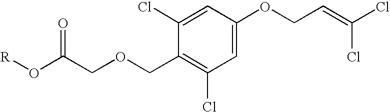

| No. | R | ¹H NMR(CDCl₃)300 MHz | Phys. data |
|---|---|---|---|
| 7.1 | H | | oil |
| 7.2 | 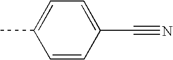 | 7.75(d, 2H), 7.35(d, 2H), 7.05(s, 2H), 6.25(t, 1H), 5.05(s, 2H), 4.75(d, 2H), 4.5(s, 2H). | oil |
| 7.3 | 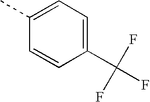 | | oil |
| 7.4 | tert-butyl | | |
| 7.5 | CH₃ | | |
| 7.6 | C₂H₅ | | |
| 7.7 | n-C₃H₇ | | |
| 7.8 | n-C₄H₉ | | |
| 7.9 | n-C₅H₁₁ | | |
| 7.10 | iso-C₃H₇ | | |
| 7.11 | 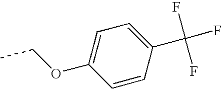 | | |
| 7.12 | 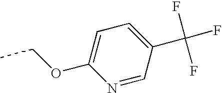 | | |
| 7.13 | 2-chloro-phenyl | | |
| 7.14 | 3-chloro-phenyl | | |
| 7.15 | 4-chloro-phenyl | | |
| 7.16 | 3,4-dichloro-phenyl | | |
| 7.17 | 3,5-dichloro-phenyl | | |
| 7.18 | 2,4-dichloro-phenyl | | |
| 7.19 | 2-bromo-phenyl | | |
| 7.20 | 3-bromo-phenyl | | |
| 7.21 | 4-bromo-phenyl | | |
| 7.22 | 3,5-dibromo-phenyl | | |
| 7.23 | 2,4-dibromo-phenyl | | |
| 7.24 | 2-fluoro-phenyl | | |
| 7.25 | 3-fluoro-phenyl | | |
| 7.26 | 4-fluoro-phenyl | | |
| 7.27 | 3,5-difluoro-phenyl | | |
| 7.28 | 2,4-difluoro-phenyl | | |
| 7.29 | 2-nitro-phenyl | | |
| 7.30 | 3-nitro-phenyl | | |
| 7.31 | 4-nitro-phenyl | | |
| 7.32 | 2-cyano-phenyl | | |
| 7.33 | 3-cyano-phenyl | | |
| 7.34 | 4-cyano-phenyl | | |
| 7.35 | 3,5-ditrifluoromethyl-phenyl | | |
| 7.36 | 3-trifluoromethyl-phenyl | | |
| 7.37 | 4-trifluoromethyl-phenyl | | |
| 7.38 | 2-methyl-phenyl | | |
| 7.39 | 3-methyl-phenyl | | |
| 7.40 | 4-methyl-phenyl | | |
| 7.41 | 3,5-dimethyl-phenyl | | |
| 7.42 | 3-methoxy-phenyl | | |
| 7.43 | 4-methoxy-phenyl | | |
| 7.44 | 3,5-dimethoxy-phenyl | | |
| 7.45 | 4-acetyl-phenyl | | |
| 7.46 | 4-acetyl-2-fluoro-phenyl | | |
| 7.47 | 3-trifluoromethyl-2-pyridyl | | |
| 7.48 | 2-chloro-5-pyridyl | | |
| 7.49 | 2,6-dichloro-4-pyridyl | | |
| 7.50 | 3-trifluoromethyl-2-pyrimidyl | | |

The compound of formula

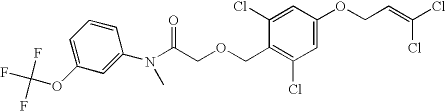

¹H NMR (CDCl₃) 300 MHz: 8.25 (s, 1H), 7.4 (s, 1H), 7.25 (t, 1H), 6.8 (d, 1H), 6.75 (s, 2H), 5.95 (t, 1H), 4.7 (s, 2H), 4.45 (d, 2H), 3.95 (s, 2H).

TABLE 8
Compounds of formula

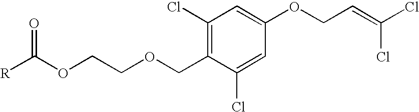

| No. | R | ¹H NMR(CDCl₃)300 MHz | Phys. data |
|---|---|---|---|
| 8.1 | 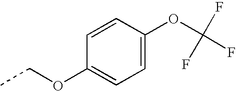 | 7.2(d, 2H), 7.0(d, 2H), 6.95(s, 2H), 6.2(t, 1H), 4.85(s, 2H), 4.7(m, 4H), 4.45(t, 2H), 3.85(t, 2H). | oil |
| 8.2 | 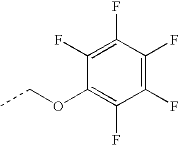 | 7.0(s, 2H), 6.2(t, 1H), 4.9(s, 2H), 4.8(s, 2H), 4.7(d, 2H), 4.45(m, 2H), 3.8(m, 2H). | oil |
| 8.3 | 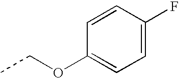 | | oil |
| 8.4 | 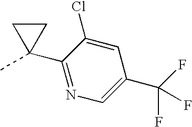 | 8.6(s, 1H), 7.85(s, 1H), 6.8(s, 2H), 6.05(t, 1H), 4.6(m, 4H), 4.25(t, 2H), 3.6(t, 2H), 1.75(m, 2H), 1.4(m, 2H). | oil |
| 8.5 | 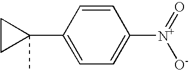 | | oil |
| 8.6 | 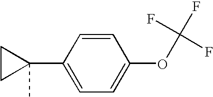 | | oil |
| 8.7 | 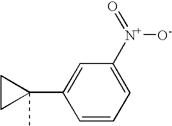 | 7.85(d, 2H), 6.85(d, 2H), 6.75(s, 2H), 5.95(t, 1H), 4.7(s, 2H), 4.45(d, 2H), 4.05(t, 2H), 3.75(t, 2H). | oil |
| 8.8 | 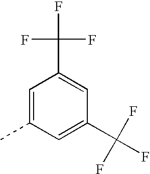 | | oil |
| 8.9 | 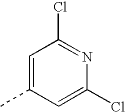 | | oil |
| 8.10 | 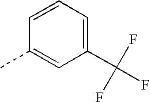 | 8.45(s, 1H), 8.25(d, 1H), 7.7(d, 1H), 7.55(t, 1H), 6.9(s, 2H), 6.15(t, 1H), 4.85(s, 2H), 4.65(d, 2H), 4.6(m, 2H), 3.9(m, 2H). | oil |
| 8.11 | 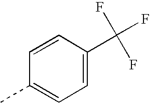 | 8.2(d, 2H), 7.7(d, 2H), 6.85(s, 2H), 6.1(t, 1H), 4.7(s, 2H), 4.65(d, 2H), 4.55(t, 2H), 3.9(t, 2H). | oil |
| 8.12 | 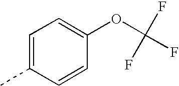 | 8.1(d, 2H), 7.25(d, 2H), 6.85(s, 2H), 6.1(t, 1H), 4.8(s, 2H), 4.65(d, 2H), 4.5(t, 2H), 3.9(t, 2H). | oil |
| 8.13 | 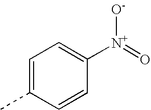 | | oil |
| 8.14 | CH₃ | | |
| 8.15 | C₂H₅ | | |
| 8.16 | n-C₃H₇ | | |
| 8.17 | n-C₄H₉ | | |
| 8.18 | n-C₅H₁₁ | | |
| 8.19 | iso-C₃H₇ | | |
| 8.20 | 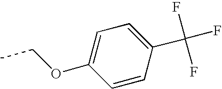 | | |
| 8.21 | 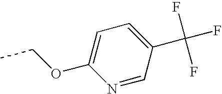 | | |
| 8.22 | 2-chloro-phenyl | | |
| 8.23 | 3-chloro-phenyl | | |
| 8.24 | 4-chloro-phenyl | | |
| 8.25 | 3,4-dichloro-phenyl | | |
| 8.26 | 3,5-dichloro-phenyl | | |
| 8.27 | 2,4-dichloro-phenyl | | |
| 8.28 | 2-bromo-phenyl | | |
| 8.29 | 3-bromo-phenyl | | |
| 8.30 | 4-bromo-phenyl | | |
| 8.31 | 3,5-dibromo-phenyl | | |
| 8.32 | 2,4-dibromo-phenyl | | |
| 8.33 | 2-fluoro-phenyl | | |
| 8.34 | 3-fluoro-phenyl | | |
| 8.35 | 4-fluoro-phenyl | | |
| 8.36 | 3,5-difluoro-phenyl | | |
| 8.37 | 2,4-difluoro-phenyl | | |
| 8.38 | 2-nitro-phenyl | | |
| 8.39 | 3-nitro-phenyl | | |
| 8.40 | 2-cyano-phenyl | | |
| 8.41 | 3-cyano-phenyl | | |
| 8.42 | 4-cyano-phenyl | | |
| 8.43 | 3,5-ditrifluoromethyl-phenyl | | |
| 8.44 | 2-methyl-phenyl | | |
| 8.45 | 3-methyl-phenyl | | |
| 8.46 | 4-methyl-phenyl | | |
| 8.47 | 3,5-dimethyl-phenyl | | |
| 8.48 | 3-methoxy-phenyl | | |
| 8.49 | 4-methoxy-phenyl | | |
| 8.50 | 3,5-dimethoxy-phenyl | | |
| 8.51 | 4-acetyl-phenyl | | |
| 8.52 | 4-acetyl-2-fluoro-phenyl | | |
| 8.53 | 3-trifluoromethyl-2-pyridyl | | |
| 8.54 | 2-chloro-5-pyridyl | | |
| 8.55 | 3-trifluoromethyl-2-pyrimidyl | | |

TABLE 9
Compounds of formula

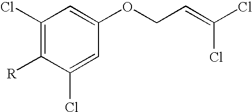

| No. | R | ¹H-NMR(CDCl₃)300 MHz |
|---|---|---|
| 9.1 | 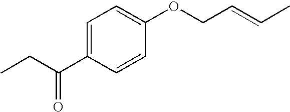 | 1.23(t, 3H); 2.99(q, 2H); 4.65(d, 2H); 4.87(dd, 2H), 6.15(t, 1H), 6.41(dt, 1H), 6.70(dt, 1H), 6.82(s, 2H), 7.05(d, 2H), 7.98(d, 2H) |
| 9.2 | 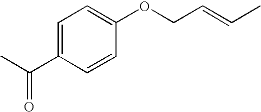 | 2.60(s, 3H), 4.65(d, 2H); 4.87(dd, 2H), 6.15(t, 1H), 6.41(dt, 1H), 6.70(dt, 1H), 6.82(s, 2H), 7.05(d, 2H), 7.98(d, 2H) |
| 9.3 | 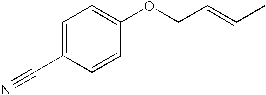 | 4.61(d, 2H), 4.82(dd, 2H), 6.13(t, 1H), 6.36(dt, 1H), 6.68(dt, 1H), 6.88(s, 2H), 7.03(d, 2H), 7.60(d, 2H) |
| 9.4 | 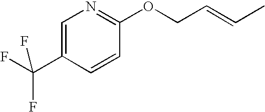 | 4.62(d, 2H), 5.10(dd, 2H), 6.13(t, 1H), 6.44(dt, 1H); 6.69(dt, 1H), 6.90(s, 2H), 6.92(s, 1H), 7.79(dd, 1H), 8.45(br s, 1H) |
| 9.5 | 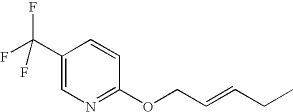 | 3.67(d, 1H), 4.61(d, 2H), 4.85(d, 2H), 5.79(dt, 1H), 5.94(dt, 1H), 6.14(t, 1H), 6.82(d, 1H), 6.89(s, 2H), 7.77(dd, 1H), 8.42(s, 2H) |
| 9.6 | 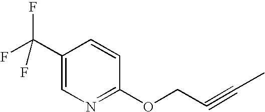 | 4.64(d, 2H), 5.36(s, 2H), 6.13(t, 1H), 6.88(s, 2H), 6.96(s, 1H), 7.83(dd, 1H), 8.51(d, 1H) |
| 9.7 | 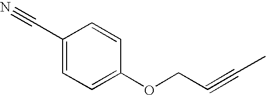 | 4.64(d, 2H), 5.08(s, 2H), 6.11(t, 1H), 6.88(s, 2H), 7.16(d, 2H), 7.63(d, 2H), 7.83(dd, 1H) |
| 9.8 | 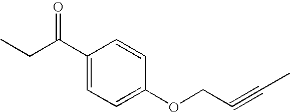 | 1.22(t, 3H), 2.98(q, 2H), 4.63(d, 2H), 5.08(s, 2H), 6.10(t, 1H), 6.88(s, 2H), 7.13(d, 2H), 7.98(d, 2H) |
| 9.9 | 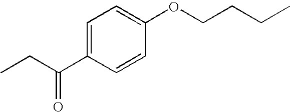 | 1.23(t, 3H), 2.10(quint, 2H), 2.96(q, 2H), 3.08(t, 2H), 4.10(t, 2H), 4.62(d, 2H), 6.13(t, 1H), 6.87(s, 2H), 6.95(d, 2H), 7.95(d, 2H) |
| 9.10 | 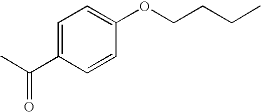 | 2.10(quint, 2H), 2.58(s, 3H), 3.08(t, 2H), 4.10(t, 2H), 4.62(d, 2H), 6.13(t, 1H), 6.87(s, 2H), 6.95(d, 2H), 7.95(d, 2H) |
| 9.11 | 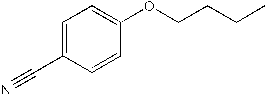 | 2.10(quint, 2H), 3.07(t, 2H), 4.08(t, 2H), 4.62(d, 2H), 6.13(t, 1H), 6.88(s, 2H); 6.96(d, 2H), 7.60(d, 2H) |
| 9.12 | 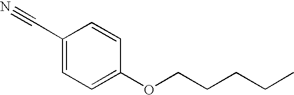 | 1.77(quint, 2H), 1.93(quint, 2H), 2.93(t, 2H), 4.07(t, 2H), 4.61(d, 2H), 6.15(t, 1H), 6.87(s, 2H), 6.96(d, 2H), 7.60(d, 2H) |
| 9.13 | 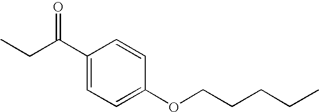 | 1.22(t, 2H), 1.77(quint, 2H), 1.92(quint, 2H), 2.94(t, 2H), 2.98(t, 2H), 4.08(t, 2H), 4.61(d, 2H), 6.13(t, 1H), 6.87(s, 2H), 6.93(d, 2H), 7.94(d, 2H) |

TABLE A
Compounds of formulae

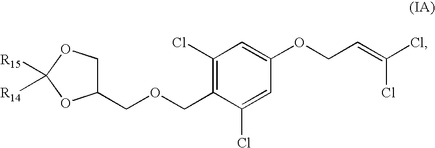

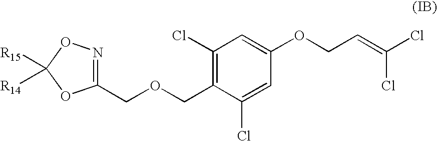

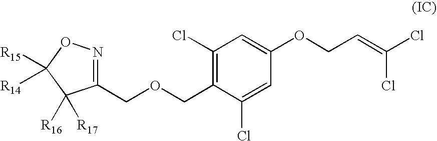

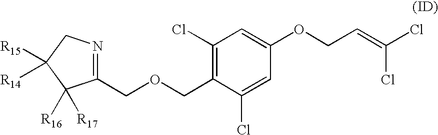

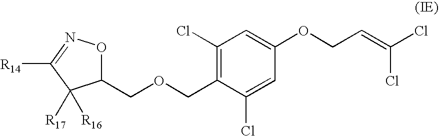

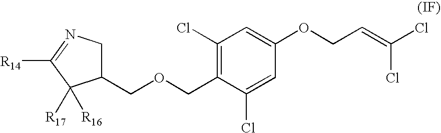

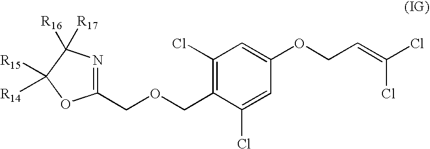

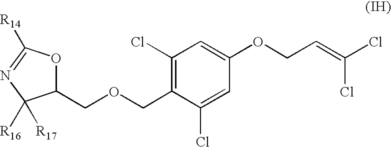

TABLE B

| No. | R₁₄ | R₁₅ | R₁₆ | R₁₇ |
|---|---|---|---|---|
| B.1 | CH₃ | H | H | H |
| B.2 | C₂H₅ | H | H | H |
| B.3 | n-C₃H₇ | H | H | H |
| B.4 | n-C₄H₉ | H | H | H |
| B.5 | n-C₅H₁₁ | H | H | H |
| B.6 | iso-C₃H₇ | H | H | H |
| B.7 | 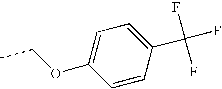 | H | H | H |
| B.8 | 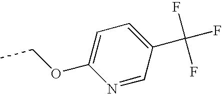 | H | H | H |
| B.9 | 2-chloro-phenyl | H | H | H |
| B.10 | 3-chloro-phenyl | H | H | H |
| B.11 | 4-chloro-phenyl | H | H | H |
| B.12 | 3,4-dichloro-phenyl | H | H | H |
| B.13 | 3,5-dichloro-phenyl | H | H | H |
| B.14 | 2,4-dichloro-phenyl | H | H | H |
| B.15 | 2-bromo-phenyl | H | H | H |
| B.16 | 3-bromo-phenyl | H | H | H |
| B.17 | 4-bromo-phenyl | H | H | H |
| B.18 | 3,5-dibromo-phenyl | H | H | H |
| B.19 | 2,4-dibromo-phenyl | H | H | H |
| B.20 | 2-fluoro-phenyl | H | H | H |
| B.21 | 3-fluoro-phenyl | H | H | H |
| B.22 | 4-fluoro-phenyl | H | H | H |
| B.23 | 3,5-difluoro-phenyl | H | H | H |
| B.24 | 2,4-difluoro-phenyl | H | H | H |
| B.25 | 2-nitro-phenyl | H | H | H |
| B.26 | 3-nitro-phenyl | H | H | H |
| B.27 | 4-nitro-phenyl | H | H | H |
| B.28 | 2-cyano-phenyl | H | H | H |
| B.29 | 3-cyano-phenyl | H | H | H |
| B.30 | 4-cyano-phenyl | H | H | H |
| B.31 | 3,5-ditrifluoromethyl-phenyl | H | H | H |
| B.32 | 3-trifluoromethyl-phenyl | H | H | H |
| B.33 | 4-trifluoromethyl-phenyl | H | H | H |
| B.34 | 2-methyl-phenyl | H | H | H |
| B.35 | 3-methyl-phenyl | H | H | H |
| B.36 | 4-methyl-phenyl | H | H | H |
| B.37 | 3,5-dimethyl-phenyl | H | H | H |
| B.38 | 3-methoxy-phenyl | H | H | H |
| B.39 | 4-methoxy-phenyl | H | H | H |
| B.40 | 3,5-dimethoxy-phenyl | H | H | H |
| B.41 | 4-acetyl-phenyl | H | H | H |
| B.42 | 4-acetyl-2-fluoro-phenyl | H | H | H |
| B.43 | 3-trifluoromethyl-2-pyridyl | H | H | H |
| B.44 | 2-chloro-5-pyridyl | H | H | H |
| B.45 | 2,6-dichloro-4-pyridyl | H | H | H |
| B.46 | 3-trifluoromethyl-2-pyrimidyl | H | H | H |
| B.47 | 4-trifluoromethyl-phenyl | H | H | H |
| B.48 | 3-trifluoromethyl-phenyl | H | H | H |
| B.49 | 2-trifluoromethyl-phenyl | H | H | H |
| B.50 | CH₃ | CH₃ | H | H |
| B.51 | C₂H₅ | CH₃ | H | H |
| B.52 | n-C₃H₇ | CH₃ | H | H |
| B.53 | n-C₄H₉ | CH₃ | H | H |
| B.54 | n-C₅H₁₁ | CH₃ | H | H |
| B.55 | iso-C₃H₇ | CH₃ | H | H |
| B.56 | 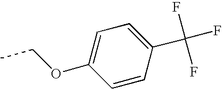 | CH₃ | H | H |
| B.57 | 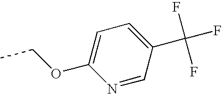 | CH₃ | H | H |
| B.58 | 2-chloro-phenyl | CH₃ | H | H |
| B.59 | 3-chloro-phenyl | CH₃ | H | H |
| B.60 | 4-chloro-phenyl | CH₃ | H | H |
| B.61 | 3,4-dichloro-phenyl | CH₃ | H | H |
| B.62 | 3,5-dichloro-phenyl | CH₃ | H | H |
| B.63 | 2,4-dichloro-phenyl | CH₃ | H | H |
| B.64 | 2-bromo-phenyl | CH₃ | H | H |
| B.65 | 3-bromo-phenyl | CH₃ | H | H |
| B.66 | 4-bromo-phenyl | CH₃ | H | H |
| B.67 | 3,5-dibromo-phenyl | CH₃ | H | H |
| B.68 | 2,4-dibromo-phenyl | CH₃ | H | H |
| B.69 | 2-fluoro-phenyl | CH₃ | H | H |
| B.70 | 3-fluoro-phenyl | CH₃ | H | H |
| B.71 | 4-fluoro-phenyl | CH₃ | H | H |
| B.72 | 3,5-difluoro-phenyl | CH₃ | H | H |
| B.73 | 2,4-difluoro-phenyl | CH₃ | H | H |
| B.74 | 2-nitro-phenyl | CH₃ | H | H |
| B.75 | 3-nitro-phenyl | CH₃ | H | H |
| B.76 | 4-nitro-phenyl | CH₃ | H | H |
| B.77 | 2-cyano-phenyl | CH₃ | H | H |
| B.78 | 3-cyano-phenyl | CH₃ | H | H |
| B.79 | 4-cyano-phenyl | CH₃ | H | H |
| B.80 | 3,5-ditrifluoromethyl-phenyl | CH₃ | H | H |
| B.81 | 3-trifluoromethyl-phenyl | CH₃ | H | H |
| B.82 | 4-trifluoromethyl-phenyl | CH₃ | H | H |
| B.83 | 2-methyl-phenyl | CH₃ | H | H |
| B.84 | 3-methyl-phenyl | CH₃ | H | H |
| B.85 | 4-methyl-phenyl | CH₃ | H | H |
| B.86 | 3,5-dimethyl-phenyl | CH₃ | H | H |
| B.87 | 3-methoxy-phenyl | CH₃ | H | H |
| B.88 | 4-methoxy-phenyl | CH₃ | H | H |
| B.89 | 3,5-dimethoxy-phenyl | CH₃ | H | H |
| B.90 | 4-acetyl-phenyl | CH₃ | H | H |
| B.91 | 4-acetyl-2-fluoro-phenyl | CH₃ | H | H |
| B.92 | 3-trifluoromethyl-2-pyridyl | CH₃ | H | H |
| B.93 | 2-chloro-5-pyridyl | CH₃ | H | H |
| B.94 | 2,6-dichloro-4-pyridyl | CH₃ | H | H |
| B.95 | 3-trifluoromethyl-2-pyrimidyl | CH₃ | H | H |
| B.96 | 4-trifluoromethyl-phenyl | CH₃ | H | H |
| B.97 | 3-trifluoromethyl-phenyl | CH₃ | H | H |
| B.98 | 2-trifluoromethyl-phenyl | CH₃ | H | H |
| B.99 | CH₃ | C₂H₅ | H | H |
| B.100 | C₂H₅ | C₂H₅ | H | H |
| B.101 | n-C₃H₇ | C₂H₅ | H | H |
| B.102 | n-C₄H₉ | C₂H₅ | H | H |
| B.103 | n-C₅H₁₁ | C₂H₅ | H | H |
| B.104 | iso-C₃H₇ | C₂H₅ | H | H |
| B.105 | 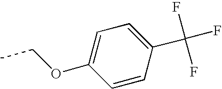 | C₂H₅ | H | H |
| B.106 | 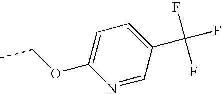 | C₂H₅ | H | H |
| B.107 | 2-chloro-phenyl | C₂H₅ | H | H |
| B.108 | 3-chloro-phenyl | C₂H₅ | H | H |
| B.109 | 4-chloro-phenyl | C₂H₅ | H | H |
| B.110 | 3,4-dichloro-phenyl | C₂H₅ | H | H |
| B.111 | 3,5-dichloro-phenyl | C₂H₅ | H | H |
| B.112 | 2,4-dichloro-phenyl | C₂H₅ | H | H |
| B.113 | 2-bromo-phenyl | C₂H₅ | H | H |
| B.114 | 3-bromo-phenyl | C₂H₅ | H | H |
| B.115 | 4-bromo-phenyl | C₂H₅ | H | H |
| B.116 | 3,5-dibromo-phenyl | C₂H₅ | H | H |
| B.117 | 2,4-dibromo-phenyl | C₂H₅ | H | H |
| B.118 | 2-fluoro-phenyl | C₂H₅ | H | H |
| B.119 | 3-fluoro-phenyl | C₂H₅ | H | H |
| B.120 | 4-fluoro-phenyl | C₂H₅ | H | H |
| B.121 | 3,5-difluoro-phenyl | C₂H₅ | H | H |
| B.122 | 2,4-difluoro-phenyl | C₂H₅ | H | H |
| B.123 | 2-nitro-phenyl | C₂H₅ | H | H |
| B.124 | 3-nitro-phenyl | C₂H₅ | H | H |
| B.125 | 4-nitro-phenyl | C₂H₅ | H | H |
| B.126 | 2-cyano-phenyl | C₂H₅ | H | H |
| B.127 | 3-cyano-phenyl | C₂H₅ | H | H |
| B.128 | 4-cyano-phenyl | C₂H₅ | H | H |
| B.129 | 3,5-ditrifluoromethyl-phenyl | C₂H₅ | H | H |
| B.130 | 3-trifluoromethyl-phenyl | C₂H₅ | H | H |
| B.131 | 4-trifluoromethyl-phenyl | C₂H₅ | H | H |
| B.132 | 2-methyl-phenyl | C₂H₅ | H | H |
| B.133 | 3-methyl-phenyl | C₂H₅ | H | H |
| B.134 | 4-methyl-phenyl | C₂H₅ | H | H |
| B.135 | 3,5-dimethyl-phenyl | C₂H₅ | H | H |
| B.136 | 3-methoxy-phenyl | C₂H₅ | H | H |
| B.137 | 4-methoxy-phenyl | C₂H₅ | H | H |
| B.138 | 3,5-dimethoxy-phenyl | C₂H₅ | H | H |
| B.139 | 4-acetyl-phenyl | C₂H₅ | H | H |
| B.140 | 4-acetyl-2-fluoro-phenyl | C₂H₅ | H | H |
| B.141 | 3-trifluoromethyl-2-pyridyl | C₂H₅ | H | H |
| B.142 | 2-chloro-5-pyridyl | C₂H₅ | H | H |
| B.143 | 2,6-dichloro-4-pyridyl | C₂H₅ | H | H |
| B.144 | 3-trifluoromethyl-2-pyrimidyl | C₂H₅ | H | H |
| B.145 | 4-trifluoromethyl-phenyl | C₂H₅ | H | H |
| B.146 | 3-trifluoromethyl-phenyl | C₂H₅ | H | H |
| B.147 | 2-trifluoromethyl-phenyl | C₂H₅ | H | H |
| B.148 | CH₃ | H | CH₃ | CH₃ |
| B.149 | C₂H₅ | H | CH₃ | CH₃ |
| B.150 | n-C₃H₇ | H | CH₃ | CH₃ |
| B.151 | n-C₄H₉ | H | CH₃ | CH₃ |
| B.152 | n-C₅H₁₁ | H | CH₃ | CH₃ |
| B.153 | iso-C₃H₇ | H | CH₃ | CH₃ |
| B.154 | 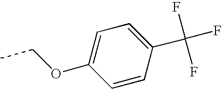 | H | CH₃ | CH₃ |
| B.155 | 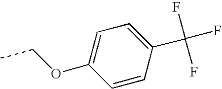 | H | CH₃ | CH₃ |
| B.156 | 2-chloro-phenyl | H | CH₃ | CH₃ |
| B.157 | 3-chloro-phenyl | H | CH₃ | CH₃ |
| B.158 | 4-chloro-phenyl | H | CH₃ | CH₃ |
| B.159 | 3,4-dichloro-phenyl | H | CH₃ | CH₃ |
| B.160 | 3,5-dichloro-phenyl | H | CH₃ | CH₃ |
| B.161 | 2,4-dichloro-phenyl | H | CH₃ | CH₃ |
| B.162 | 2-bromo-phenyl | H | CH₃ | CH₃ |
| B.163 | 3-bromo-phenyl | H | CH₃ | CH₃ |
| B.164 | 4-bromo-phenyl | H | CH₃ | CH₃ |
| B.165 | 3,5-dibromo-phenyl | H | CH₃ | CH₃ |
| B.166 | 2,4-dibromo-phenyl | H | CH₃ | CH₃ |
| B.167 | 2-fluoro-phenyl | H | CH₃ | CH₃ |
| B.168 | 3-fluoro-phenyl | H | CH₃ | CH₃ |
| B.169 | 4-fluoro-phenyl | H | CH₃ | CH₃ |
| B.170 | 3,5-difluoro-phenyl | H | CH₃ | CH₃ |
| B.171 | 2,4-difluoro-phenyl | H | CH₃ | CH₃ |
| B.172 | 2-nitro-phenyl | H | CH₃ | CH₃ |
| B.173 | 3-nitro-phenyl | H | CH₃ | CH₃ |
| B.174 | 4-nitro-phenyl | H | CH₃ | CH₃ |
| B.175 | 2-cyano-phenyl | H | CH₃ | CH₃ |
| B.176 | 3-cyano-phenyl | H | CH₃ | CH₃ |
| B.177 | 4-cyano-phenyl | H | CH₃ | CH₃ |
| B.178 | 3,5-ditrifluoromethyl-phenyl | H | CH₃ | CH₃ |
| B.179 | 3-trifluoromethyl-phenyl | H | CH₃ | CH₃ |
| B.180 | 4-trifluoroemthyl-phenyl | H | CH₃ | CH₃ |
| B.181 | 2-methyl-phenyl | H | CH₃ | CH₃ |
| B.182 | 3-methyl-phenyl | H | CH₃ | CH₃ |
| B.183 | 4-methyl-phenyl | H | CH₃ | CH₃ |
| B.184 | 3,5-dimethyl-phenyl | H | CH₃ | CH₃ |
| B.185 | 3-methoxy-phenyl | H | CH₃ | CH₃ |
| B.186 | 4-methoxy-phenyl | H | CH₃ | CH₃ |
| B.187 | 3,5-dimethoxy-phenyl | H | CH₃ | CH₃ |
| B.188 | 4-acetyl-phenyl | H | CH₃ | CH₃ |
| B.189 | 4-acetyl-2-fluoro-phenyl | H | CH₃ | CH₃ |
| B.190 | 3-trifluoromethyl-2-pyridyl | H | CH₃ | CH₃ |
| B.191 | 2-chloro-5-pyridyl | H | CH₃ | CH₃ |
| B.192 | 2,6-dichloro-4-pyridyl | H | CH₃ | CH₃ |
| B.193 | 3-trifluoromethyl-2-pyrimidyl | H | CH₃ | CH₃ |
| B.194 | 4-trifluoromethyl-phenyl | H | CH₃ | CH₃ |
| B.195 | 3-trifluoromethyl-phenyl | H | CH₃ | CH₃ |
| B.196 | 2-trifluoromethyl-phenyl | H | CH₃ | CH₃ |
| B.197 | CH₃ | H | H | CH₃ |
| B.198 | C₂H₅ | H | H | CH₃ |
| B.199 | n-C₃H₇ | H | H | CH₃ |
| B.200 | n-C₄H₉ | H | H | CH₃ |
| B.201 | n-C₅H₁₁ | H | H | CH₃ |
| B.202 | iso-C₃H₇ | H | H | CH₃ |
| B.203 | 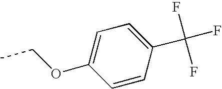 | H | H | CH₃ |
| B.204 | 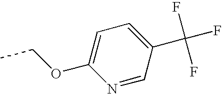 | H | H | CH₃ |
| B.205 | 2-chloro-phenyl | H | H | CH₃ |
| B.206 | 3-chloro-phenyl | H | H | CH₃ |
| B.207 | 4-chloro-phenyl | H | H | CH₃ |
| B.208 | 3,4-dichloro-phenyl | H | H | CH₃ |
| B.209 | 3,5-dichloro-phenyl | H | H | CH₃ |
| B.210 | 2,4-dichloro-phenyl | H | H | CH₃ |
| B.211 | 2-bromo-phenyl | H | H | CH₃ |
| B.212 | 3-bromo-phenyl | H | H | CH₃ |
| B.213 | 4-bromo-phenyl | H | H | CH₃ |
| B.214 | 3,5-dibromo-phenyl | H | H | CH₃ |
| B.215 | 2,4-dibromo-phenyl | H | H | CH₃ |
| B.216 | 2-fluoro-phenyl | H | H | CH₃ |
| B.217 | 3-fluoro-phenyl | H | H | CH₃ |
| B.218 | 4-fluoro-phenyl | H | H | CH₃ |
| B.219 | 3,5-difluoro-phenyl | H | H | CH₃ |
| B.220 | 2,4-difluoro-phenyl | H | H | CH₃ |
| B.221 | 2-nitro-phenyl | H | H | CH₃ |
| B.222 | 3-nitro-phenyl | H | H | CH₃ |
| B.223 | 4-nitro-phenyl | H | H | CH₃ |
| B.224 | 2-cyano-phenyl | H | H | CH₃ |
| B.225 | 3-cyano-phenyl | H | H | CH₃ |
| B.226 | 4-cyano-phenyl | H | H | CH₃ |
| B.227 | 3,5-ditrifluoromethyl-phenyl | H | H | CH₃ |
| B.228 | 3-trifluoromethyl-phenyl | H | H | CH₃ |
| B.229 | 4-trifluoromethyl-phenyl | H | H | CH₃ |
| B.230 | 2-methyl-phenyl | H | H | CH₃ |
| B.231 | 3-methyl-phenyl | H | H | CH₃ |
| B.232 | 4-methyl-phenyl | H | H | CH₃ |
| B.233 | 3,5-dimethyl-phenyl | H | H | CH₃ |
| B.234 | 3-methoxy-phenyl | H | H | CH₃ |
| B.235 | 4-methoxy-phenyl | H | H | CH₃ |
| B.236 | 3,5-dimethoxy-phenyl | H | H | CH₃ |
| B.237 | 4-acetyl-phenyl | H | H | CH₃ |
| B.238 | 4-acetyl-2-fluoro-phenyl | H | H | CH₃ |
| B.239 | 3-trifluoromethyl-2-pyridyl | H | H | CH₃ |
| B.240 | 2-chloro-5-pyridyl | H | H | CH₃ |
| B.241 | 2,6-dichloro-4-pyridyl | H | H | CH₃ |
| B.242 | 3-trifluoromethyl-2-pyrimidyl | H | H | CH₃ |

Table 10: Compounds of the general formula (IA) wherein the combination of the substituents R₁₄ and R₁₅ for a compound corresponds to each of lines B.1 to B.242 of Table B.

Table 11: Compounds of the general formula (IB) wherein the combination of the substituents R₁₄ and R₁₅ for a compound corresponds to each of lines B.1 to B.242 of Table B.

Table 12: Compounds of the general formula (IC) wherein the combination of the substituents R₁₄ to R₁₇ for a compound corresponds to each of lines B.1 to B.242 of Table B.

Table 13: Compounds of the general formula (ID) wherein the combination of the substituents R₁₄ to R₁₇ for a compound corresponds to each of lines B.1 to B.242 of Table B.

Table 14: Compounds of the general formula (IE) wherein the combination of the substituents R₁₄, R₁₆ and R₁₇ for a compound corresponds to each of lines B.1 to B.242 of Table B.

Table 15: Compounds of the general formula (IF) wherein the combination of the substituents R₁₄, R₁₆ and R₁₇ for a compound corresponds to each of lines B.1 to B.242 of Table B.

Table 16: Compounds of the general formula (IG) wherein the combination of the substituents R₁₄ to R₁₇ for a compound corresponds to each of lines B.1 to B.242 of Table B.

Table 17: Compounds of the general formula (1H) wherein the combination of the substituents R₁₄, R₁₆ and R₁₇ for a compound corresponds to each of lines B.1 to B.242 of Table B.

### FORMULATION EXAMPLES

### %=Percent by Weight

| Example F1: Emulsifiable concentrates | a) | b) | c) |
|---|---|---|---|
| active ingredient | 25% | 40% | 50% |
| calcium dodecylbenzenesulfonate | 5% | 8% | 6% |
| castor oil polyethylene glycol ether (36 mol EO) | 5% | — | — |
| tributylphenol polyethylene glycol ether | — | 12% | 4% |
| (30 mol EO) | | | |
| cyclohexanone | — | 15% | 20% |
| xylene mixture | 65% | 25% | 20% |

Mixing finely ground active ingredient and additives gives an emulsifiable concentrate which yields emulsions of the desired concentration on dilution with water.

| Example F2: Solutions | a) | b) | c) | d) |
|---|---|---|---|---|
| active ingredient | 80% | 10% | 5% | 95% |
| ethylene glycol monomethyl ether | 20% | — | — | — |
| polyethylene glycol (MW 400) | — | 70% | — | — |
| N-methylpyrrolid-2-one | — | 20% | — | — |
| epoxidised coconut oil | — | — | 1% | 5% |
| benzine (boiling range: 160-190°) | — | — | 94% | — |

Mixing finely ground active ingredient and additives gives a solution suitable for use in the form of microdrops.

| Example F3: Granules | a) | b) | c) | d) |
|---|---|---|---|---|
| active ingredient | 5% | 10% | 8% | 21% |
| kaolin | 94% | — | 79% | 54% |
| highly dispersed silicic acid | 1% | — | 13% | 7% |
| attapulgite | — | 90% | — | 18% |

The active ingredient is dissolved in dichloromethane, the solution is sprayed onto the carrier mixture and the solvent is evaporated off in vacuo.

### BIOLOGICAL EXAMPLES

### Example B1

### Action Against Heliothis virescens Caterpillars

Young soybean plants are sprayed with an aqueous emulsion spray mixture comprising 400 ppm of active ingredient. After the spray-coating has dried, the soybean plants are populated with 10 caterpillars of Heliothis virescens in the first stage and placed in a plastics container. Evaluation is made 6 days later. The percentage reduction in population and the percentage reduction in feeding damage (% activity) are determined by comparing the number of dead caterpillars and the feeding damage on the treated plants with that on the untreated plants.

The compounds of the Tables exhibit good activity against Heliothis virescens in this test. In particular, compounds 1.2, 1.3, 1.12, 2.3, 2.8, 2.10, 2.12, 2.15, 2.17, 3.12, 3.15, 4.4, 4.11, 5.6, 5.9, 5.14, 6.23, 7.5 and 8.12 exhibit an activity of more than 80%.

### Example B2

### Action Against Plutella xylostella Caterpillars

Young cabbage plants are sprayed with an aqueous emulsion spray mixture comprising 400 ppm of active ingredient. After the spray-coating has dried, the cabbage plants are populated with 10 caterpillars of Plutella xylostella in the third stage and placed in a plastics container. Evaluation is made 3 days later. The percentage reduction in population and the percentage reduction in feeding damage (% activity) are determined by comparing the number of dead caterpillars and the feeding damage on the treated plants with that on the untreated plants.

The compounds of the Tables exhibit good activity against Plutella xylostella.

In particular, compounds 1.3, 1.8, 1.12, 1.14, 1.21, 2.3, 2.8, 2.10, 2.12, 2.15, 2.17, 3.12, 3.15, 4.4, 4.11, 5.6, 5.9, 5.14, 6.23, 7.5 and 8.12 exhibit an activity of more than 80%.

### Example B3

### Action Against Spodoptera littoralis

Young soybean plants are sprayed with an aqueous emulsion spray mixture comprising 400 ppm of test compound and, after the spray-coating has dried, the plants are populated with 10 caterpillars of Spodoptera littoralis in the first stage and then placed in a plastics container. 3 days later, the percentage reduction in population and the percentage reduction in feeding damage (% activity) are determined by comparing the number of dead caterpillars and the feeding damage on the treated plants with that on untreated plants.

The compounds of the Tables exhibit good activity in this test. In particular, compounds 1.2, 1.3, 1.12, 2.3, 2.8, 2.10, 2.12, 2.15, 3.12, 3.15, 4.11, 5.6, 5.14, 6.23, 7.5, 8.11 and 8.12 exhibit an activity of more than 80%.

1. A compound of formula 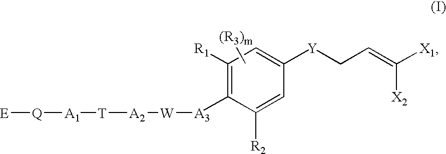
wherein
A₁ and A₂ independently of each other are a bond, C₁-C₆alkylene, C₂-C₆alkenylene or C₂-C₆alkynylene which are unsubstituted or substituted from one to six times by, each independently of the other(s), C₃-C₈cycloalkyl or C₁-C₃haloalkyl; or a ring of formula 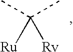
wherein the bonds indicated by --- denote the connections to the structural moieties W and T, or T and Q respectively, and Ru and Rv together are C₂-C₆alkylene;
A₃ is C₁-C₆alkylene, C₂-C₆alkenylene or C₂-C₆alkynylene which are unsubstituted or substituted from one to six times by, each independently of the other(s), C₃-C₈cycloalkyl or C₁-C₃haloalkyl;
W is O, NR₇, S, —C(═O)—O—, —O—C(═O)—, —O—C(═O)—NR₈—, —NR—C(═O)—O—, —NR₈C(═O)—NR₈—, —C(═O)—NH—NR₈— or —NR₈—NHC(═O)—;
T is a bond, O, NH, NR₇, S, SO, SO₂, —C(═O)—O—, —O—C(═O)—, —C(═O)—NR₈— or —NR₈—C(═O)—; or is a five- or six-membered, saturated or unsaturated ring, containing from one to three hetero atoms selected from O, S and N, which is unsubstituted or substituted by C₁-C₆alkyl and to which the adjacent groups A₁ and A₂ are bonded via carbon atoms of the ring;
Q is a bond, O, NR₇, S, SO or SO₂;
Y is O, NR₇, S, SO or SO₂;
X₁ and X₂ are each independently of the other fluorine, chlorine, bromine or iodine;
R₁ is halogen, CN, nitro, C₁-C₆alkyl, C₁-C₆haloalkyl, C₁-C₆alkylcarbonyl, C₂-C₆alkenyl, C₂-C₆haloalkenyl, C₂-C₆alkynyl, C₁-C₆alkoxy, C₁-C₆haloalkoxy, C₂-C₆alkenyloxy, C₂-C₆haloalkenyloxy, C₂-C₆alkynyloxy, C₁-C₆alkoxycarbonyl or C₂-C₆haloalkenyloxy;
R₂ and R₃ are each independently of the other H, halogen, CN, nitro, C₁-C₆alkyl, C₁-C₆haloalkyl, C₁-C₆alkylcarbonyl, C₂-C₆alkenyl, C₂-C₆haloalkenyl, C₂-C₆alkynyl, C₁-C₆alkoxy, C₁-C₆haloalkoxy, C₂-C₆alkenyloxy, C₂-C₆haloalkenyloxy, C₂-C₆alkynyloxy, C₁-C₆alkoxycarbonyl or C₂-C₆haloalkenyloxy; the substituents R₃ being independent of one another when m is 2;
R₇ is H, —CHO, C₁-C₆alkyl, C₁-C₃haloalkyl, C₁-C₃haloalkylcarbonyl, C₁-C₆alkoxyalkyl, C₁-C₆alkylcarbonyl, C₁-C₆alkoxycarbonyl or C₃-C₈cycloalkyl;
R₈ is H, C₁-C₆alkyl, C₁-C₃haloalkyl, C₁-C₃haloalkylcarbonyl, C₁-C₆alkoxyalkyl, C₁-C₆alkylcarbonyl, C₃-C₈cycloalkyl or benzyl;
m is 1 or 2; and
E is C₁-C₆alkyl, C₃-C₈cycloalkyl, C₁-C₆haloalkyl, aryl or saturated or unsaturated heterocyclyl;
the aryl and heterocyclyl rings being unsubstituted or, depending on the substitution possibilities, substituted from one to five times by, each independently of the other(s), halogen, NH₂, OH, CN, nitro, C₁-C₆alkyl, C₁-C₆haloalkyl, C₁-C₆alkylcarbonyl, C₂-C₆alkenyl which is unsubstituted or substituted by halogen, CN or by benzoyl; C₂-C₆alkynyl, C₁-C₆alkoxy, C₁-C₆alkylthio, C₁-C₆haloalkoxy, C₁-C₆haloalkylthio, C₂-C₆alkenyloxy, C₂-C₆haloalkenyloxy, C₂-C₆alkynyloxy, C₁-C₆alkoxycarbonyl, C₂-C₆haloalkenyloxy, C₁-C₆haloalkyl, R₉, aryl, aryloxy, —O—CH₂-aryl, aminoaryl, heterocyclyl, heterocyclyloxy, —O—CH₂-heterocyclyl or aryl-C₁-C₆alkyl; or, substituting two adjacent ring atoms together, —O—CH₂—O— or —O—CF₂—O—;
it being possible for the last-mentioned aryl, aryloxy, —O—CH₂-aryl, aminoaryl, heterocyclyl, heterocyclyloxy, —O—CH₂-heterocyclyl and aryl-C₁-C₆alkyl groups to be unsubstituted or substituted by from one to three substituents selected each independently of the other(s) from halogen, CN, nitro, C₁-C₆alkyl, C₁-C₆haloalkyl, C₁-C₆alkoxy, C₁-C₆alkylthio and C₁-C₆haloalkoxy;
R₉ is —C(═NOR₁₀)—C₁-C₆alkyl; and
R₁₀ is H, C₁-C₆alkyl, C₃-C₆cycloalkyl-C₁-C₆alkyl, C₂-C₆alkenyl or C₂-C₆alkynyl;
and, where applicable, to possible E/Z isomers, mixtures of E/Z isomers and/or tautomers thereof, in each case in free form or in salt form,
with the proviso, that E is not pyrid-2-yl, which is substituted by CF₃ in the 4-position and unsubstituted or substituted by halogen in the 6-position, when A₃ is n-butylene or n-pentylene, W is oxygen, R₁ and R₂ are chlorine, m is 0, Y is oxygen, X₁ and X₂ are chlorine and A₁, A₂, T and Q are bonds.

2. A compound of formula (I) according to claim 1 in free form.

3. A compound of formula (I) according to claim 1, wherein X₁ and X₂ are chlorine or bromine.

4. A compound of formula (I) according to claim 1, wherein A₃ is —CH₂—.

5. A compound of formula (I) according to claim 1, wherein W is oxygen.

6. A compound of formula (I) according to claim 1, wherein Q is a bond.

7. A pesticidal composition comprising as active ingredient at least one compound of formula (I) according to claim 1, in free form or in agrochemically usable salt form, and at least one adjuvant.

8. A method of controlling pests, which comprises applying a pesticidal composition as described in claim 7 to the pests or to the locus thereof.

9. (canceled)
